(19) United States
(12) Patent Application Publication
(10) Pub. No.: US 2026/0254787 A1
(43) Pub. Date: Aug. 27, 2026

(54) SYSTEM

(71) Applicant: SoftBank Group Corp., Tokyo (JP)

(72) Inventor: Naoya OTSUKA, Tokyo (JP)

(73) Assignee: SoftBank Group Corp., Tokyo (JP)

(21) Appl. No.: 19/542,667

(22) Filed: Feb. 18, 2026

(30) Foreign Application Priority Data
Feb. 21, 2025 (JP) 2025-026981

(51) Int. Cl. H04L 51/52; G06F 16/353; G06N 3/045; H04L 51/02

(52) U.S. Cl. CPC H04L 51/52; G06F 16/353; G06N 3/045; H04L 51/02

(57) ABSTRACT

The system according to the embodiment comprises a collection unit, a detection unit, a generation unit, and a posting unit. The collection unit collects contents of a comment section. The detection unit analyzes comments collected by the collection unit and detects comments lacking fairness or non-constructive comments. The generation unit generates comments from another perspective or constructive comments for the comments detected by the detection unit. The posting unit posts the comments generated by the generation unit.

### CROSS-REFERENCE TO RELATED APPLICATION

The present application claims priority to and incorporates by reference the entire contents of Japanese Patent Application No. 2025-026981 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, many comments lacking fairness or non-constructive comments are frequently observed in comment sections, and there is room for improvement.

### SUMMARY OF THE INVENTION

The system according to the embodiment comprises a collection unit, a detection unit, a generation unit, and a posting unit. The collection unit collects contents of a comment section. The detection unit analyzes comments collected by the collection unit and detects comments lacking fairness or non-constructive comments. The generation unit generates comments from another perspective or constructive comments for the comments detected by the detection unit. The posting unit posts the comments generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

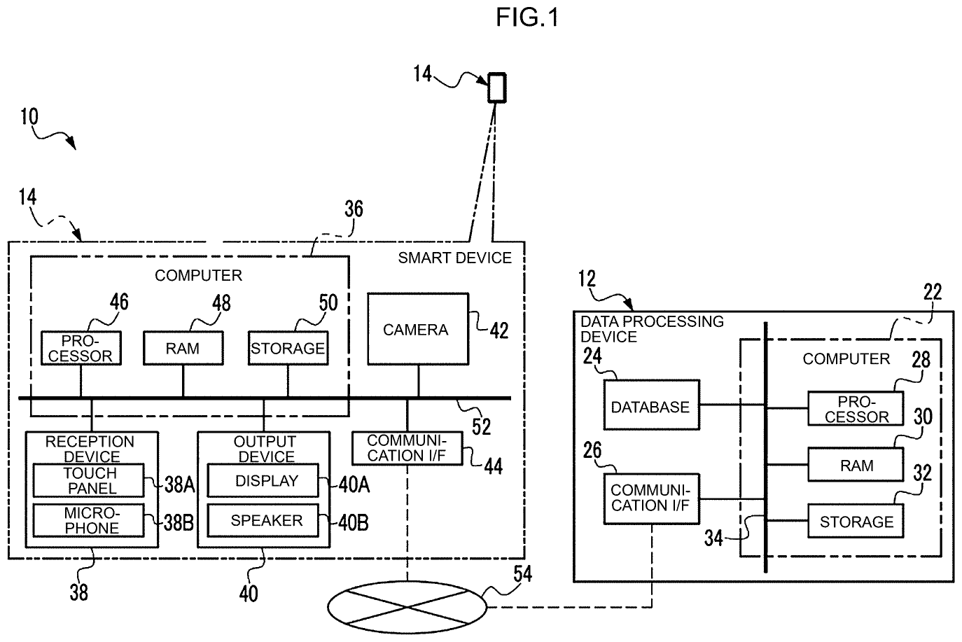

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

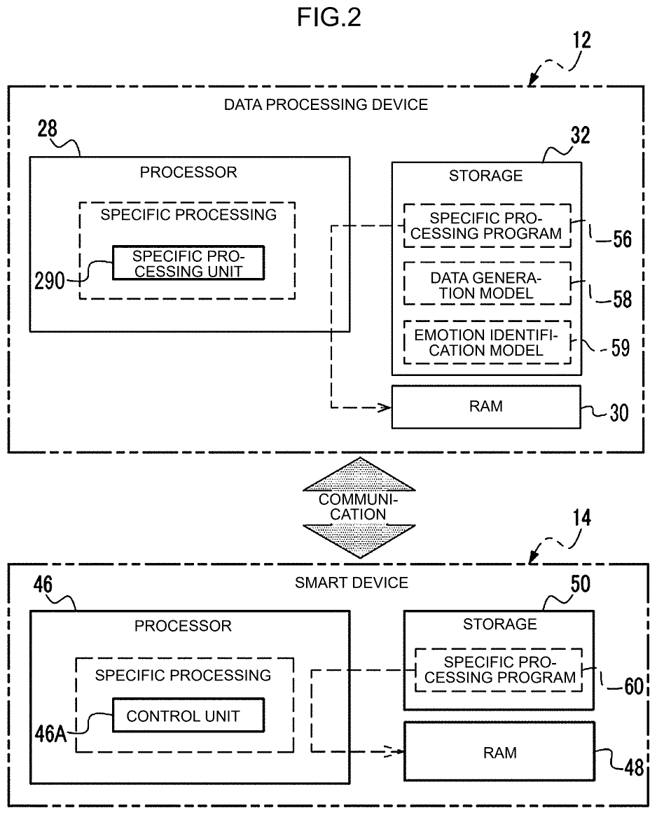

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The comment promotion system according to the embodiment of the present invention is a system that collects contents of a comment section, and for comments lacking fairness or non-constructive comments, generates and posts comments from another perspective or constructive comments. This comment promotion system analyzes the contents of the comment section and detects comments lacking fairness or non-constructive comments. Next, the comment promotion system generates comments from another perspective or constructive comments for the detected comments. The generated comments are posted to the comment section. For example, the comment promotion system collects contents of the comment section. For example, the comment promotion system uses natural language processing technology to understand the content of comments and detect comments lacking fairness or non-constructive comments. Next, the comment promotion system uses generative AI to generate appropriate responses to the detected comments. For example, for comments biased toward a specific opinion, the system presents opinions from different perspectives, and for comments that attack others, it generates comments that promote constructive discussion. The generated comments are posted to the comment section. As a result, discussions in the comment section become more diverse, and constructive communication is promoted. For example, presenting opinions from different perspectives to comments biased toward a specific opinion deepens the discussion, and promoting constructive discussion in response to comments that attack others makes the comment section a meaningful place. Thus, the comment promotion system can be expected to make the comment section a meaningful and rich text communication space. By collecting, analyzing, generating, and posting the contents of the comment section, the comment promotion system can provide a meaningful and rich text communication space. Specifically, the comment promotion system first uses a collection unit equipped with web scraping technology and API integration functions to automatically collect various data formats of comments, such as text comments, image comments, and video comments. The collection unit acquires comment data to be collected as string arrays, image tensors (e.g., 224×224×3 RGB images), and video frame sequences (e.g., 30 fps continuous images), and stores them in a database linked to time series and poster attributes. Next, the detection unit of the system applies natural language processing algorithms (e.g., BERT-based context understanding models or Transformer architectures) to the collected comment data, tokenizes and vectorizes the content of each comment (e.g., 768-dimensional sentence embedding vectors), and inputs them into pre-trained classification models (e.g., binary classifier for fairness judgment, multi-class classifier for non-constructiveness judgment). Examples of input include text data such as “This opinion is one-sided” or “You are wrong,” and image data containing aggressive facial expressions. The detection unit generates as output a fairness score for each comment (e.g., continuous value from 0.0 to 1.0), a constructiveness label (e.g., constructive/non-constructive), and the underlying features (e.g., frequency of aggressive vocabulary, sentiment analysis score). For example, for the comment “You are wrong,” a fairness score of 0.2 and a constructiveness label of “non-constructive” may be output. These outputs are selected as response generation target comments in the subsequent generation unit by threshold judgment (e.g., fairness score below 0.5, constructiveness label is non-constructive). The generation unit inputs the comments and their attribute information passed from the detection unit as prompts into a large language model (e.g., Transformer-type LLM with billions of parameters) or a multimodal generation model. Examples of input include “Generate a constructive opinion from a different perspective for this comment within 200 characters” or “Generate a response that encourages calm discussion to an aggressive comment.” The generation unit outputs natural language text (e.g., “There is another way to look at this issue . . . ”), and, if necessary, response data in image or video format. The generated comments are posted to the comment section via API by the posting unit. The posting unit automatically performs sending of posting requests, response analysis of posting results, and retry processing in case of posting failure. Through this series of processes, the system goes beyond simple human automation and solves technical challenges that were previously difficult, such as high-dimensional feature extraction by AI, multi-perspective generation, and real-time posting optimization. The technical effects include a significant improvement in the diversity and constructiveness of discussions in the comment section, suppression of flaming and the spread of prejudice, and realization of a healthy communication space. Specific application fields include news sites, SNS, online learning platforms, corporate communication tools, and any user-generated content service.

The comment promotion system according to the embodiment comprises a collection unit, a detection unit, a generation unit, and a posting unit. The collection unit collects contents of a comment section. The contents of the comment section may include, for example, text comments, image comments, and video comments, but are not limited to such examples. The collection unit may use web scraping technology to collect contents of the comment section. The collection unit may also acquire comment data using an API. For example, the collection unit may use web scraping technology to collect data from the comment section of a specific website. When using an API, the collection unit sends a request to acquire comment data and analyzes the data returned as a response. The detection unit analyzes comments collected by the collection unit and detects comments lacking fairness or non-constructive comments. The detection unit may use natural language processing technology to analyze the content of comments. For example, the detection unit may use text analysis algorithms to detect specific keywords or phrases. The detection unit may also classify the content of comments using machine learning models. For example, the detection unit may filter comments containing specific keywords or phrases to detect comments containing prejudice or discrimination. When using machine learning models, the detection unit trains the model using training data and classifies the content of comments. The generation unit uses generative AI to generate comments from another perspective or constructive comments for comments detected by the detection unit. The generation unit may use a text generation AI (e.g., LLM) to generate comments. For example, the generation unit may generate comments that present opinions from different perspectives for comments biased toward a specific opinion. The generation unit may also generate comments that promote constructive discussion for comments that attack others. For example, the generation unit may input a prompt such as “Please generate an opinion from a different perspective for this comment” into the generative AI and obtain the generated comment. The posting unit posts the comments generated by the generation unit to the comment section. The posting unit may use an API to post comments. The posting unit sends a request to post the generated comment to the comment section and analyzes the data returned as a response. Thus, the comment promotion system according to the embodiment can provide a meaningful and rich text communication space by collecting, analyzing, generating, and posting the contents of the comment section. Specifically, the collection unit utilizes web scraping technology and API integration functions to acquire text comments as string arrays (e.g., “This opinion is one-sided”), image comments as image tensors (e.g., 224×224×3 RGB images), and video comments as video frame sequences (e.g., 30 fps continuous images), and stores them in a database linked to posting time and poster attributes (e.g., user ID, age, region). The collection unit performs preprocessing such as noise removal, normalization, and feature extraction (e.g., face detection, text normalization) on the collected data. The detection unit inputs the collected comment data into natural language processing algorithms (e.g., BERT-based context understanding models or Transformer architectures), tokenizes and vectorizes each comment (e.g., 768-dimensional sentence embedding vectors), and inputs them into pre-trained classification models (e.g., binary classifier for fairness judgment, multi-class classifier for non-constructiveness judgment). Examples of input include text data such as “You are wrong” or “This opinion is one-sided,” and image data containing aggressive facial expressions. The detection unit outputs a fairness score for each comment (e.g., continuous value from 0.0 to 1.0), a constructiveness label (e.g., constructive/non-constructive), and the underlying features (e.g., frequency of aggressive vocabulary, sentiment analysis score). For example, for the comment “You are wrong,” a fairness score of 0.2 and a constructiveness label of “non-constructive” may be output. These outputs are selected as response generation target comments in the subsequent generation unit by threshold judgment (e.g., fairness score below 0.5, constructiveness label is non-constructive). The generation unit inputs the comments and their attribute information passed from the detection unit as prompts into a large language model or a multimodal generation model. Examples of input include “Generate a constructive opinion from a different perspective for this comment within 200 characters” or “Generate a response that encourages calm discussion to an aggressive comment.” The generation unit outputs natural language text (e.g., “There is another way to look at this issue . . . ”), and, if necessary, response data in image or video format. The generated comments are posted to the comment section via API by the posting unit. The posting unit automatically performs sending of posting requests, response analysis of posting results, and retry processing in case of posting failure. Through this series of processes, the system goes beyond simple human automation and solves technical challenges that were previously difficult, such as high-dimensional feature extraction by AI, multi-perspective generation, and real-time posting optimization. The technical effects include a significant improvement in the diversity and constructiveness of discussions in the comment section, suppression of flaming and the spread of prejudice, and realization of a healthy communication space. Specific application fields include news sites, SNS, online learning platforms, corporate communication tools, and any user-generated content service.

The collection unit can estimate a user's emotion and adjust the timing of comment collection based on the estimated emotion of the user. The collection unit may use facial recognition technology to estimate a user's emotion. For example, the collection unit analyzes facial data of the user captured by a camera to estimate emotion. The collection unit may also use text analysis technology to estimate emotion from the content of the user's comments. For example, the collection unit analyzes keywords or phrases contained in the user's comments and calculates an emotion score. Furthermore, the collection unit may use voice analysis technology to estimate emotion from the user's voice data. For example, the collection unit analyzes the tone and speed of the user's voice and calculates an emotion score. The collection unit adjusts the timing of comment collection based on the estimated emotion of the user. For example, if the user is excited, the collection unit increases the frequency of comment collection to promote real-time responses. If the user is calm, the collection unit may reduce the frequency of comment collection and collect at regular intervals. If the user is tired, the collection unit may temporarily stop comment collection and resume after a break. By adjusting the timing of comment collection according to the user's emotion, the collection unit can collect comments at more appropriate times. Emotion estimation is realized using, for example, an emotion engine or a generative AI with emotion estimation functions. Generative AI may be a text generation AI (e.g., LLM) or a multimodal generative AI, but is not limited to such examples. Specifically, the collection unit combines multiple modality inputs for user emotion estimation. For facial recognition, image data obtained from a camera (e.g., 224×224×3 RGB image tensor) is input into a CNN-based facial classification model to obtain a probability distribution of emotion labels such as “joy,” “anger,” “sadness,” and “surprise” (e.g., softmax output). Examples of input include images of smiling faces, frowning faces, and crying faces. For text analysis, the user's comment text (e.g., “I'm really angry,” “I'm happy today”) is input into a BERT-based sentence embedding model to obtain a 768-dimensional vector representation, and an emotion classifier calculates emotion scores (e.g., anger 0.8, joy 0.1, sadness 0.1). For voice analysis, the user's voice waveform data (e.g., 16 kHz sampling, 3-second audio clip) is input into an RNN or Transformer-based voice emotion recognition model after MFCC feature extraction, and outputs emotion labels and confidence scores such as “anger” and “joy.” These multiple emotion estimation results are integrated using ensemble methods or weighted averages to obtain a final emotion estimation value (e.g., anger 0.7, joy 0.2, sadness 0.1). The collection unit executes a comment collection timing control algorithm based on this emotion estimation value. For example, if the anger score is 0.6 or higher, the collection interval is shortened to 1 second; if the joy score is 0.8 or higher, the interval is set to 5 seconds, applying threshold-based control logic. Furthermore, if the user is determined to be in a fatigue state (e.g., sadness score 0.7 or higher, decreased voice energy), comment collection is stopped for a certain period and resumed after the user's state recovers. These controls realize dynamic collection optimization according to user state, unlike conventional simple periodic collection. The technical effects include the ability to acquire comment data at timing that matches the user's psychological state, enabling the collection of important statements during emotional peaks and balanced opinions in calm states, greatly improving the quality and diversity of data. It also reduces unnecessary data collection and server load, contributing to overall system efficiency. Specific application fields include real-time comment collection in live streaming services, emotion monitoring in online counseling platforms, and understanding student reactions in educational settings, applicable to various user interaction environments.

The collection unit can perform filtering based on specific keywords or phrases at the time of comment collection. The collection unit may filter comments based on specific keywords or phrases. For example, the collection unit may preferentially collect comments containing specific political keywords. The collection unit may also exclude comments containing aggressive phrases during collection. Furthermore, the collection unit may collect comments containing keywords related to specific topics. For example, the collection unit may filter comments containing keywords related to specific topics and preferentially collect highly relevant comments. By performing filtering based on specific keywords or phrases, the collection unit can collect highly relevant comments. Some or all of the above-described processing in the collection unit may be performed using AI or without using AI. For example, the collection unit may use an AI model to filter comments containing specific keywords or phrases and collect comments. Specifically, the collection unit acquires comment data as string arrays (e.g., “This policy has problems,” “I cannot support XX party”), applies normalization processing (e.g., lowercasing, symbol removal, stop word removal), and executes an algorithm that matches against a keyword dictionary or phrase list (e.g., political keyword list, aggressive expression list, topic-related word list). In simple rule-based filtering, each comment text is tokenized and each token is sequentially checked for inclusion in the dictionary. When using an AI model, the comment text is input into a BERT or Transformer-based text classification model, and the output is a relevance score for each keyword category (e.g., politics category 0.8, aggression category 0.1, topic A category 0.6). Examples of input include text data such as “This policy has problems” and “Your opinion is wrong.” The output of the AI model is used for selection of comments to be collected by threshold judgment (e.g., politics category score 0.7 or higher for preferential collection, aggression category 0.5 or higher for exclusion). Furthermore, when multiple keywords or phrases appear simultaneously, weighted scoring or priority rules (e.g., always exclude if aggressive expressions are included) may be applied. These processes realize high-precision comment selection based on contextual understanding and multidimensional features, unlike conventional simple keyword matching filtering. The technical effects include efficient collection of only highly relevant comments, contributing to improved accuracy of subsequent analysis and generation processing and optimization of system-wide computational resources. In addition, by preventing the inclusion of unnecessary aggressive comments and noise data, it also contributes to maintaining a healthy communication space. Specific application fields include political discussion sites, corporate customer support chats, and opinion collection systems in educational settings, widely applicable to comment collection environments where topic or expression control is important.

The collection unit can analyze a user's past comment history at the time of comment collection and determine the priority of comments to be collected. The collection unit may analyze a user's past comment history. For example, the collection unit analyzes the content and frequency of comments previously posted by the user. The collection unit may also analyze evaluations and reactions to the user's comments. For example, if the user has previously posted constructive comments, the collection unit may preferentially collect that user's comments. If the user has previously posted biased opinions, the collection unit may postpone collection of that user's comments. Furthermore, the collection unit may preferentially collect comments related to specific topics based on the user's past comment history. For example, if the user has frequently posted comments on a specific topic in the past, the collection unit may preferentially collect comments related to that topic. By analyzing a user's past comment history, the collection unit can appropriately determine the priority of comments to be collected. Some or all of the above-described processing in the collection unit may be performed using AI or without using AI. For example, the collection unit may use an AI model to analyze a user's past comment history and determine the priority of comments. Specifically, the collection unit builds a comment history database for each user (e.g., structured data including user ID, comment text, posting time, evaluation score, topic label, etc.) and executes a history analysis algorithm. When using an AI model, the user's past comments are input as a time series vector (e.g., each comment vectorized by BERT embedding and input as a time series array) into an LSTM or Transformer-based sequence classification model, which outputs user tendencies (e.g., constructiveness score, bias score, topic interest score). Examples of input include “the last 30 comment texts” and “evaluation values for each comment (e.g., number of likes, number of reports).” The output of the AI model may be numerical values such as constructiveness score 0.9, bias score 0.2, topic A interest score 0.8, and these are used to apply priority calculation logic (e.g., prioritize comments from users with high constructiveness scores, postpone those with high bias scores). Furthermore, reactions from other users to the user's comments (e.g., number of approvals, number of disapprovals, number of replies) may also be added as features to calculate a comprehensive priority score. These processes realize dynamic priority optimization by multidimensional feature analysis using AI, unlike conventional simple time series or frequency-based prioritization. The technical effects include efficient collection of comments from users with constructive and diverse opinions, contributing to improved quality of discussion, suppression of the spread of prejudice, and maintenance of overall system health. Specific application fields include online discussion platforms, corporate employee opinion collection systems, and management of student remarks in educational settings, applicable to environments where comment selection based on user attributes and history is important.

The collection unit can estimate a user's emotion and determine the priority of comments to be collected based on the estimated emotion of the user. The collection unit may use facial recognition technology to estimate a user's emotion. For example, the collection unit analyzes facial data of the user captured by a camera to estimate emotion. The collection unit may also use text analysis technology to estimate emotion from the content of the user's comments. For example, the collection unit analyzes keywords or phrases contained in the user's comments and calculates an emotion score. Furthermore, the collection unit may use voice analysis technology to estimate emotion from the user's voice data. For example, the collection unit analyzes the tone and speed of the user's voice and calculates an emotion score. The collection unit determines the priority of comments to be collected based on the estimated emotion of the user. For example, if the user is angry, the collection unit preferentially collects that user's comments and responds quickly. If the user is happy, the collection unit may postpone collection of that user's comments. If the user is sad, the collection unit may preferentially collect that user's comments and respond appropriately. By determining the priority of comments to be collected according to the user's emotion, the collection unit can preferentially collect appropriate comments. Emotion estimation is realized using, for example, an emotion engine or a generative AI with emotion estimation functions. Generative AI may be a text generation AI (e.g., LLM) or a multimodal generative AI, but is not limited to such examples. Specifically, the collection unit combines multiple modality inputs (image, text, voice) for user emotion estimation. For facial recognition, image tensor data obtained from a camera (e.g., 224×224×3 RGB image) is input into a CNN-based facial classification model to obtain a probability distribution of emotion labels such as “anger,” “joy,” and “sadness” (e.g., softmax output). Examples of input include images of angry faces, smiling faces, and crying faces. For text analysis, the user's comment text (e.g., “I'm really angry,” “I'm happy today”) is input into a BERT-based sentence embedding model to obtain a 768-dimensional vector, and an emotion classifier calculates emotion scores (e.g., anger 0.8, joy 0.1, sadness 0.1). For voice analysis, voice waveform data (e.g., 16 kHz sampling, 3-second audio clip) is input into an RNN or Transformer-based voice emotion recognition model after MFCC feature extraction, and outputs emotion labels and confidence scores. These multiple emotion estimation results are integrated using ensemble methods or weighted averages to obtain a final emotion estimation value (e.g., anger 0.7, joy 0.2, sadness 0.1). The collection unit applies a priority control algorithm based on this emotion estimation value (e.g., prioritize collection if anger score is 0.6 or higher, postpone if joy score is 0.8 or higher). These processes realize dynamic priority optimization according to user state, unlike conventional simple periodic or random collection. The technical effects include the ability to collect important statements during emotional peaks and balanced opinions in calm states without omission, greatly improving the quality and diversity of data. It also reduces unnecessary data collection and server load, contributing to overall system efficiency. Specific application fields include real-time comment collection in live streaming services, emotion monitoring in online counseling, and understanding student reactions in educational settings, applicable to various user interaction environments.

The collection unit can preferentially collect highly relevant comments based on the user's geographic location information at the time of comment collection. The collection unit may use GPS data to acquire the user's geographic location information. For example, the collection unit analyzes GPS data obtained from the user's device to identify the user's current location. The collection unit may also estimate the user's geographic location information using an IP address. For example, the collection unit analyzes the user's IP address to identify the user's approximate location. The collection unit preferentially collects highly relevant comments based on the user's geographic location information. For example, if the user is in a specific region, the collection unit preferentially collects comments related to that region. If the user is in a different region, the collection unit may postpone collection of comments related to that region. Furthermore, the collection unit may preferentially collect comments related to specific events based on the user's geographic location information. For example, the collection unit preferentially collects comments related to events held in a specific region. By considering the user's geographic location information, the collection unit can preferentially collect highly relevant comments. Some or all of the above-described processing in the collection unit may be performed using AI or without using AI. For example, the collection unit may use an AI model to analyze the user's geographic location information and collect comments. Specifically, the collection unit stores GPS data obtained from the user's device (e.g., latitude and longitude pairs) or region information estimated from the IP address (e.g., prefecture, city/town level) linked to each comment in the comment database. When using an AI model, multidimensional vectors combining the user's location information and comment content (e.g., location information vector +text embedding vector) are input, and region relevance scores or event relevance scores are output. Examples of input include “latitude 35.6895, longitude 139.6917, comment: I attended an event in Shibuya” or “IP address 203.0.113.1, comment: I'm interested in the weather in Hokkaido.” The output of the AI model may be numerical values such as region relevance score 0.9, event relevance score 0.8, and these are used to apply priority judgment logic (e.g., prioritize collection if region relevance score is 0.7 or higher). Furthermore, when multiple regions or events are simultaneously related, weighted scoring or event priority rules may be applied. These processes realize dynamic region/event relevance optimization by high-dimensional feature analysis using AI, unlike conventional simple region name matching or manual selection. The technical effects include efficient collection of comments with high regionality or event relevance, greatly improving the comprehensiveness and immediacy of information in region-limited services, event management support, and disaster site information collection. Specific application fields include regional community sites, tourism information platforms, disaster information sharing systems, and event management support tools, applicable to comment collection environments where geographic context is important.

The collection unit can analyze a user's social media activity at the time of comment collection and collect related comments. The collection unit may analyze a user's social media activity. For example, the collection unit analyzes the content and frequency of posts made by the user on social media. The collection unit may also analyze the user's number of followers and engagement. For example, if the user frequently posts about a specific topic on social media, the collection unit preferentially collects comments related to that topic. If the user posts aggressive comments on social media, the collection unit may exclude that user's comments. Furthermore, the collection unit may analyze the user's social media activity and collect comments related to specific keywords. For example, the collection unit analyzes specific keywords used by the user on social media and preferentially collects comments related to those keywords. By analyzing a user's social media activity, the collection unit can appropriately collect related comments. Some or all of the above-described processing in the collection unit may be performed using AI or without using AI. For example, the collection unit may use an AI model to analyze a user's social media activity and collect comments. Specifically, the collection unit collects the user's social media posting history (e.g., structured data including post text, posting time, number of likes, number of retweets, number of followers, topic labels, etc.) and executes an analysis algorithm. When using an AI model, the user's post content is input into a BERT or Transformer-based text classification model, which outputs aggression score, topic relevance score, engagement score, etc. Examples of input include text data such as “Recently posting frequently about XX” or “Many posts containing aggressive expressions,” and numerical data such as “10,000 followers, engagement rate 0.2.” The output of the AI model may be numerical values such as aggression score 0.7, topic A relevance score 0.9, engagement score 0.8, and these are used to apply priority judgment logic (e.g., exclude if aggression score is 0.5 or higher, prioritize collection if topic relevance score is 0.7 or higher). Furthermore, the frequency of user posts and the level of engagement may be used to dynamically adjust the frequency and priority of comment collection. These processes realize dynamic priority optimization by multidimensional feature analysis using AI, unlike conventional simple reference to posting history or manual selection. The technical effects include efficient collection of comments with high topic relevance and soundness, contributing to improved quality of discussion, reduced risk of flaming, and maintenance of overall system health. Specific application fields include SNS-linked comment collection systems, brand monitoring tools, and online community management systems, applicable to environments where social media activity is important.

The detection unit can estimate a user's emotion and adjust the criteria for detecting comments lacking fairness or non-constructive comments based on the estimated emotion of the user. The detection unit may use facial recognition technology to estimate a user's emotion. For example, the detection unit analyzes facial data of the user captured by a camera to estimate emotion. The detection unit may also use text analysis technology to estimate emotion from the content of the user's comments. For example, the detection unit analyzes keywords or phrases contained in the user's comments and calculates an emotion score. Furthermore, the detection unit may use voice analysis technology to estimate emotion from the user's voice data. For example, the detection unit analyzes the tone and speed of the user's voice and calculates an emotion score. The detection unit adjusts the criteria for detecting comments lacking fairness or non-constructive comments based on the estimated emotion of the user. For example, if the user is angry, the detection unit tightens the criteria for detecting aggressive comments. If the user is relaxed, the detection unit may loosen the criteria. If the user is sad, the detection unit may adjust the criteria for detecting emotional comments. By adjusting the criteria according to the user's emotion, the detection unit can more accurately detect comments lacking fairness or non-constructive comments. Emotion estimation is realized using, for example, an emotion engine or a generative AI with emotion estimation functions. Generative AI may be a text generation AI (e.g., LLM) or a multimodal generative AI, but is not limited to such examples. Specifically, the detection unit combines multiple modality inputs for user emotion estimation. For facial recognition processing, image tensor data obtained from a camera (e.g., 224×224×3 RGB image) is input into a CNN-based facial classification model to obtain a probability distribution of emotion labels such as “anger,” “joy,” “sadness,” and “surprise” (e.g., softmax output). Examples of input include images of angry faces, smiling faces, and crying faces. For text analysis processing, the user's comment text (e.g., “I'm really angry,” “I'm happy today”) is input into a BERT-based sentence embedding model to obtain a 768-dimensional vector representation, and an emotion classifier calculates emotion scores (e.g., anger 0.8, joy 0.1, sadness 0.1). For voice analysis processing, voice waveform data (e.g., 16 kHz sampling, 3-second audio clip) is input into an RNN or Transformer-based voice emotion recognition model after MFCC feature extraction, and outputs emotion labels and confidence scores such as “anger” and “joy.” These multiple emotion estimation results are integrated using ensemble methods or weighted averages to obtain a final emotion estimation value (e.g., anger 0.7, joy 0.2, sadness 0.1). The detection unit executes a comment detection criteria control algorithm based on this emotion estimation value. For example, if the anger score is 0.6 or higher, the detection threshold for aggressive expressions is set to 0.3; if the joy score is 0.8 or higher, the detection threshold is relaxed to 0.7, applying threshold-based control logic. The detection unit, as an AI model, inputs comment text and emotion estimation value simultaneously into a BERT or Transformer-based text classification model, and outputs a fairness score (e.g., 0.0 to 1.0), a constructiveness label (e.g., constructive/non-constructive), and the underlying features (e.g., frequency of aggressive vocabulary, sentiment analysis score). Examples of input include a comment such as “You are wrong” with an anger score of 0.8, or “I'm happy today” with a joy score of 0.9. The output of the AI model may be a fairness score of 0.2, a constructiveness label of “non-constructive,” and these are passed to subsequent response generation or posting units. These processes realize dynamic optimization of detection criteria according to user state, unlike conventional simple keyword matching or static rule-based detection. The technical effects include high-precision detection of aggressive statements during emotional peaks and balanced opinions in calm states, greatly reducing false detections and omissions. It also reduces unnecessary detection processing and server load, contributing to overall system efficiency. Specific application fields include real-time comment monitoring in live streaming services, emotion monitoring in online counseling, and management of student remarks in educational settings, applicable to various user interaction environments.

The detection unit can improve detection accuracy by considering the context or background information of comments at the time of detection. The detection unit may analyze the context before and after a comment. For example, the detection unit analyzes sentences before and after a comment to accurately detect aggressive comments. The detection unit may also consider background information of comments. For example, the detection unit collects background information related to specific topics and detects non-constructive comments based on that information. Furthermore, the detection unit may use natural language processing technology to understand the context of comments. For example, the detection unit analyzes the context of comments and detects misleading comments. By considering the context or background information of comments, the detection unit can improve detection accuracy. Some or all of the above-described processing in the detection unit may be performed using AI or without using AI. For example, the detection unit may use an AI model to analyze the context or background information of comments and perform detection. Specifically, the detection unit, for context analysis of comments, acquires not only individual comments but also sequences of preceding and following comments or entire threads as time-series text arrays (e.g., each comment vectorized by BERT or Transformer-based sentence embedding, input as a sequence of up to 10 consecutive comments). The detection unit inputs these context information into a Transformer-type model with self-attention mechanism to analyze the semantic relationships and flow of each comment in high-dimensional space. Examples of input include sequences of comments such as “A: This policy has problems B: I don't think so C: You are wrong,” or “the flow of discussion about event A.” For background information, topic metadata (e.g., topic name under discussion, summary of related news articles, event occurrence time) is added as additional features and integrated as multimodal input vectors. The output of the AI model includes aggression score for each comment (e.g., 0.0 to 1.0), constructiveness label (e.g., constructive/non-constructive), risk score for inducing misunderstanding (e.g., 0.0 to 1.0), and contextual features (e.g., degree of conflict with previous comment, relevance to topic). For example, if the comment “You are wrong” is in strong conflict with the previous comment, an aggression score of 0.8 and misunderstanding risk of 0.7 may be output. These outputs are input into subsequent threshold judgment logic (e.g., aggression score 0.5 or higher, misunderstanding risk 0.6 or higher for response generation target) or dynamic detection criteria adjustment modules. Furthermore, the detection unit, unlike conventional simple keyword matching or static rule-based detection, models context dependency and background dependency with high accuracy using self-attention mechanisms and multidimensional feature integration. The technical effects include high-precision discrimination of cases where the same expression has different meanings depending on context (e.g., distinguishing “sarcasm as a joke” from “aggressive criticism”), greatly reducing false detections and omissions. Flexible optimization of detection criteria according to topic or event background is also possible, improving overall system detection accuracy and reliability. Specific application fields include thread monitoring in SNS and bulletin boards, discussion management in online learning platforms, and harassment detection in corporate chats, widely applicable to comment analysis environments with high context dependency.

The detection unit can perform detection by considering attribute information of the comment poster at the time of detection. The detection unit may acquire attribute information of the comment poster. For example, the detection unit collects attribute information such as the user's age, gender, and occupation. The detection unit may also analyze the user's past comment history. For example, the detection unit analyzes the content and frequency of comments previously posted by the user. The detection unit performs detection based on attribute information of the comment poster. For example, if the comment poster has previously posted aggressive comments, the detection unit prioritizes detection of that user's comments. The detection unit may also detect non-constructive comments related to specific attributes based on attribute information of the comment poster. Furthermore, the detection unit may detect comments containing prejudice against specific attributes by considering attribute information of the comment poster. By considering attribute information of the comment poster, the detection unit can detect non-constructive comments related to specific attributes. Some or all of the above-described processing in the detection unit may be performed using AI or without using AI. For example, the detection unit may use an AI model to analyze attribute information of the comment poster and perform detection. Specifically, the detection unit builds a user attribute database (e.g., structured data including user ID, age, gender, occupation, region, organization, past posting history, evaluation score, etc.), and assigns poster attribute vectors (e.g., age category, gender one-hot, occupation category, embedding vectors of the last 30 comments, etc.) to each comment. The detection unit integrates these attribute information and comment text embeddings (e.g., 768-dimensional vectors from BERT or Transformer-based models) as multidimensional features and inputs them into an AI model (e.g., attribute-conditioned text classification model). Examples of input include “User ID 123, age 25, male, engineer, comment: This opinion is unacceptable,” or “User ID 456, age 60, female, teacher, comment: Young people don't understand.” The detection unit inputs past comment history as time-series vectors (e.g., array of BERT embeddings for the last 30 comments) into an LSTM or Transformer-based sequence classification model to calculate posting tendencies (e.g., aggression score, constructiveness score, bias score). The output of the AI model includes aggression score for each comment (e.g., 0.0 to 1.0), constructiveness label (e.g., constructive/non-constructive), attribute-related risk score (e.g., attribute discrimination risk 0.8), and these are used to apply detection criteria control logic (e.g., strict judgment for users with past aggression score 0.7 or higher, priority detection for attribute discrimination risk 0.6 or higher). Furthermore, the detection unit performs correlation analysis between attribute information and comment content (e.g., co-occurrence frequency analysis of attribute×expression, attribute-conditioned sentiment analysis) to detect prejudice or discriminatory expressions against specific attributes. These processes realize dynamic detection optimization by multidimensional integration of user attributes, history, and posting tendencies, unlike conventional simple text analysis or static rule-based detection. The technical effects include greatly improved detection accuracy for attribute discrimination and prejudice, and reduced omission of aggressive statements or harassment against specific attributes. Dynamic optimization of detection criteria based on attribute information also improves overall system health and fairness. Specific application fields include corporate communication monitoring, bullying detection in educational settings, and countermeasures against attribute discrimination in SNS, widely applicable to comment analysis environments with high attribute dependency.

The generation unit can estimate a user's emotion and adjust the expression method of generated comments based on the estimated emotion of the user. The generation unit may use facial recognition technology to estimate a user's emotion. For example, the generation unit analyzes facial data of the user captured by a camera to estimate emotion. The generation unit may also use text analysis technology to estimate emotion from the content of the user's comments. For example, the generation unit analyzes keywords or phrases contained in the user's comments and calculates an emotion score. Furthermore, the generation unit may use voice analysis technology to estimate emotion from the user's voice data. For example, the generation unit analyzes the tone and speed of the user's voice and calculates an emotion score. The generation unit adjusts the expression method of generated comments based on the estimated emotion of the user. For example, if the user is angry, the generation unit generates calm and constructive comments. If the user is relaxed, the generation unit may generate friendly comments. If the user is sad, the generation unit may generate encouraging comments. By adjusting the expression method of comments according to the user's emotion, the generation unit can generate appropriate comments. Emotion estimation is realized using, for example, an emotion engine or a generative AI with emotion estimation functions. Generative AI may be a text generation AI (e.g., LLM) or a multimodal generative AI, but is not limited to such examples. Specifically, the generation unit combines multiple modality inputs (image, text, voice) for user emotion estimation. For facial recognition, image tensor data obtained from a camera (e.g., 224×224×3 RGB image) is input into a CNN-based facial classification model to obtain a probability distribution of emotion labels such as “anger,” “joy,” and “sadness” (e.g., softmax output). Examples of input include images of angry faces, smiling faces, and crying faces. For text analysis, the user's comment text (e.g., “I'm really angry,” “I'm happy today”) is input into a BERT-based sentence embedding model to obtain a 768-dimensional vector, and an emotion classifier calculates emotion scores (e.g., anger 0.8, joy 0.1, sadness 0.1). For voice analysis, voice waveform data (e.g., 16 kHz sampling, 3-second audio clip) is input into an RNN or Transformer-based voice emotion recognition model after MFCC feature extraction, and outputs emotion labels and confidence scores. These multiple emotion estimation results are integrated using ensemble methods or weighted averages to obtain a final emotion estimation value (e.g., anger 0.7, joy 0.2, sadness 0.1). The generation unit executes a generation prompt control algorithm based on this emotion estimation value. For example, if the anger score is 0.6 or higher, the prompt template is dynamically switched to “Respond with calm and constructive expression”; if the sadness score is 0.7 or higher, “Respond with encouragement or empathy.” The generative AI model (e.g., Transformer-type LLM with billions of parameters or multimodal generation model) receives as input an attribute-attached prompt such as “User emotion: anger 0.8, comment: I'm really angry,” and outputs natural language text according to the emotion (e.g., “Let's discuss calmly,” “I understand your feelings”) or, if necessary, response data in image or video format. Examples of output include “Let's exchange opinions calmly on this issue,” “I empathize with your feelings.” These outputs are passed to the subsequent posting unit and optimized in conjunction with posting timing and display method. These processes realize dynamic expression optimization according to user state, unlike conventional static template responses or simple automatic generation. The technical effects include prevention of inappropriate responses or misunderstandings during emotional peaks, and significant improvement in user experience quality and communication health. The combination of AI-based multimodal emotion estimation and generation prompt control enables individually optimized responses that were previously difficult. Specific application fields include real-time response generation in live streaming services, empathetic responses in online counseling, and student support in educational settings, widely applicable to emotion-adaptive communication support environments.

The generation unit can adjust the level of detail of generated comments based on the importance of the comments at the time of generation. The generation unit may evaluate the importance of comments by analyzing the depth of content and influence. For example, the generation unit evaluates how detailed the content of a comment is and how many people it influences. The generation unit adjusts the level of detail of generated comments based on the importance of the comments. For important topics, the generation unit generates detailed comments. For less important topics, the generation unit may generate concise comments. Furthermore, the generation unit may generate comments with an appropriate level of detail according to the importance of the comments. For example, for important topics, the generation unit generates comments containing specific information or detailed explanations, and for less important topics, generates concise comments that capture the main points. By adjusting the level of detail according to the importance of the comments, the generation unit can generate appropriate comments. Some or all of the above-described processing in the generation unit may be performed using AI or without using AI. For example, the generation unit may use an AI model to evaluate the importance of comments and adjust the level of detail. Specifically, the generation unit receives as input the comment text passed from the detection unit (e.g., “This policy has a major impact on society,” “The weather is nice today”) and related metadata (e.g., posting time, poster attributes, topic label, number of past reactions). The generation unit inputs these data into a BERT or Transformer-based sentence embedding model to generate a 768-dimensional vector representation. Furthermore, the generation unit inputs these vectors and metadata into an importance evaluation AI model (e.g., multilayer perceptron or classifier with attention mechanism) to calculate an importance score (e.g., continuous value from 0.0 to 1.0) and influence score (e.g., score based on expected viewers, number of past reactions). Examples of input include a comment such as “This policy has a major impact on society” with 1,000 past reactions, outputting an importance score of 0.9 and influence score of 0.95. Conversely, for “The weather is nice today,” an importance score of 0.2 and influence score of 0.1 may be output. The generation unit executes a generation prompt control algorithm based on these scores. For example, if the importance score is 0.7 or higher, the prompt template is dynamically switched to “Generate a response including detailed explanation and specific examples”; if below 0.3, “Generate only a concise summary.” The generative AI model (e.g., Transformer-type large language model with billions of parameters) receives as input an attribute-attached prompt such as “Importance: 0.9, comment: This policy has a major impact on society,” and outputs detailed natural language text (e.g., “This policy affects various fields such as economy, education, and healthcare. Specifically . . . ”) or, if necessary, response data including charts or reference information. Examples of output include “This policy may affect economic growth rates. As a past example . . . ” or concise comments such as “The weather is nice today.” These outputs are passed to the subsequent posting unit and optimized in conjunction with posting timing and display method. These processes realize dynamic detail optimization by multidimensional feature analysis using AI, unlike conventional static template responses or simple automatic generation. The technical effects include providing responses with sufficient information and persuasiveness for important discussions or influential topics, and omitting redundant information for less important topics, contributing to optimization of system-wide computational resources and communication bandwidth. It also improves user experience quality, discussion efficiency, and suppresses misunderstanding and information overload. Specific application fields include explanatory comment generation for news sites, corporate knowledge sharing systems, question and answer support in educational settings, and topic-based response optimization in SNS, applicable to various environments where information provision according to importance is required.

The generation unit can apply different generation algorithms based on the category of comments at the time of generation. The generation unit may set specific criteria to classify the category of comments. For example, the generation unit classifies comments into categories such as political comments, technical comments, and social comments. The generation unit applies different generation algorithms based on the category of comments. For example, for political comments, the generation unit applies a balanced generation algorithm. For technical comments, the generation unit may apply a specialized generation algorithm. For social comments, the generation unit may apply a generation algorithm that considers emotion. For example, for political comments, the generation unit applies a generation algorithm that presents different perspectives; for technical comments, a generation algorithm that reflects specialized knowledge. By applying generation algorithms according to the category of comments, the generation unit can generate appropriate comments. Some or all of the above-described processing in the generation unit may be performed using AI or without using AI. For example, the generation unit may use an AI model to classify the category of comments and apply different generation algorithms. Specifically, the generation unit receives as input the comment text passed from the detection unit (e.g., “This policy has problems,” “New technology has been introduced,” “The happiness of society as a whole is important”). The generation unit inputs these comments into a BERT or Transformer-based sentence embedding model to generate a 768-dimensional vector representation. Next, the generation unit inputs these vectors into a category classification AI model (e.g., multi-class classifier or classifier with self-attention mechanism), which outputs category labels (e.g., politics, technology, society, economy, education) and category confidence scores (e.g., politics 0.9, technology 0.1, society 0.0). Examples of input include a comment such as “This policy has problems” with a politics category score of 0.95, or “New technology has been introduced” with a technology category score of 0.98. The generation unit executes a generation algorithm selection logic according to the category label. For example, for the politics category, a “balanced perspective presentation algorithm” (e.g., prompt template that automatically generates opinions from different positions); for the technology category, an “algorithm that uses many technical terms and examples”; for the society category, an “empathetic response generation algorithm reflecting sentiment analysis results,” dynamically switching between multiple generative AI models or prompt templates. The generative AI model (e.g., Transformer-type large language model with billions of parameters or domain-specific sub-models) receives as input an attribute-attached prompt such as “Category: politics, comment: This policy has problems,” and outputs natural language text optimized for the category (e.g., for politics: “There are pros and cons to this policy. In favor: . . . Against: . . . ”; for technology: “This technology doubles processing speed compared to conventional methods”). Examples of output include “This policy contributes to economic growth, but concerns about widening disparities have also been pointed out,” or “The introduction of new technology has greatly improved data processing efficiency.” These outputs are passed to the subsequent posting unit and optimized in conjunction with posting timing and display method. These processes realize category-adaptive generation optimization by multidimensional feature analysis using AI, unlike conventional uniform generation by a single model or static template responses. The technical effects include optimal response generation according to the characteristics of each category and discussion context, improving user experience quality, enhancing diversity and expertise of discussions, and reducing misunderstanding and risk of flaming. Collaboration with domain-specific models also improves overall system response accuracy and reliability. Specific application fields include category-specific comment generation for news sites, corporate knowledge sharing systems, domain-specific question and answer support in educational settings, and topic-based response optimization in SNS, applicable to various environments where category-adaptive information provision is required.

The posting unit can estimate a user's emotion and adjust the timing of posting comments based on the estimated emotion of the user. The posting unit may use facial recognition technology to estimate a user's emotion. For example, the posting unit analyzes facial data of the user captured by a camera to estimate emotion. The posting unit may also use text analysis technology to estimate emotion from the content of the user's comments. For example, the posting unit analyzes keywords or phrases contained in the user's comments and calculates an emotion score. Furthermore, the posting unit may use voice analysis technology to estimate emotion from the user's voice data. For example, the posting unit analyzes the tone and speed of the user's voice and calculates an emotion score. The posting unit adjusts the timing of posting comments based on the estimated emotion of the user. For example, if the user is angry, the posting unit delays posting until the user calms down. If the user is relaxed, the posting unit may post immediately. If the user is sad, the posting unit may post at an appropriate timing. By adjusting the timing of posting comments according to the user's emotion, the posting unit can post comments at appropriate timing. Emotion estimation is realized using, for example, an emotion engine or a generative AI with emotion estimation functions. Generative AI may be a text generation AI (e.g., LLM) or a multimodal generative AI, but is not limited to such examples. Specifically, the posting unit combines multiple modality inputs (image, text, voice) for user emotion estimation. For facial recognition, image tensor data obtained from a camera (e.g., 224×224×3 RGB image) is input into a CNN-based facial classification model to obtain a probability distribution of emotion labels such as “anger,” “joy,” and “sadness” (e.g., softmax output). Examples of input include images of angry faces, smiling faces, and crying faces. For text analysis, the user's comment text (e.g., “I'm really angry,” “I'm happy today”) is input into a BERT-based sentence embedding model to obtain a 768-dimensional vector, and an emotion classifier calculates emotion scores (e.g., anger 0.8, joy 0.1, sadness 0.1). For voice analysis, voice waveform data (e.g., 16 kHz sampling, 3-second audio clip) is input into an RNN or Transformer-based voice emotion recognition model after MFCC feature extraction, and outputs emotion labels and confidence scores. These multiple emotion estimation results are integrated using ensemble methods or weighted averages to obtain a final emotion estimation value (e.g., anger 0.7, joy 0.2, sadness 0.1). The posting unit executes a posting timing control algorithm based on this emotion estimation value. For example, if the anger score is 0.6 or higher, posting is delayed by 5 minutes; if the joy score is 0.8 or higher, posting is immediate; if the sadness score is 0.7 or higher, posting is held until the user's state stabilizes, applying threshold-based control logic. Furthermore, if the user's emotional state changes while waiting to post, the posting unit may re-estimate emotion and dynamically readjust posting timing. These processes realize dynamic posting optimization according to user state, unlike conventional static posting timing or simple automatic posting. The technical effects include prevention of careless posting or misleading statements during emotional peaks, and promotion of constructive communication in calm states. The combination of AI-based multimodal emotion estimation and posting timing control enables individually optimized posting that was previously difficult. Specific application fields include real-time posting control in live streaming services, emotion-adaptive posting in online counseling, and management of student remarks in educational settings, widely applicable to emotion-adaptive communication support environments.

The posting unit can determine the priority of posting based on the contents of comments at the time of posting. The posting unit may analyze the contents of comments. For example, the posting unit evaluates how important the content of a comment is and how many people it influences. The posting unit determines the priority of posting based on the contents of comments. For example, important comments are posted preferentially. Less important comments may be postponed. Furthermore, the posting unit may post comments with appropriate priority according to the content. For example, important comments are posted promptly, while less important comments are postponed. By determining the priority of posting based on the contents of comments, the posting unit can preferentially post important comments. Some or all of the above-described processing in the posting unit may be performed using AI or without using AI. For example, the posting unit may use an AI model to analyze the contents of comments and determine the priority of posting. Specifically, the posting unit receives as input the comment text passed from the generation unit (e.g., “This policy has a major impact on society,” “The weather is nice today”) and related metadata (e.g., posting time, poster attributes, topic label, number of past reactions). The posting unit inputs these data into a BERT or Transformer-based sentence embedding model to generate a 768-dimensional vector representation. Furthermore, the posting unit inputs these vectors and metadata into an importance evaluation AI model (e.g., multilayer perceptron or classifier with attention mechanism) to calculate an importance score (e.g., continuous value from 0.0 to 1.0) and influence score (e.g., score based on expected viewers, number of past reactions). Examples of input include a comment such as “This policy has a major impact on society” with 1,000 past reactions, outputting an importance score of 0.9 and influence score of 0.95. Conversely, for “The weather is nice today,” an importance score of 0.2 and influence score of 0.1 may be output. The posting unit executes a posting priority control algorithm based on these scores. For example, if the importance score is 0.7 or higher, posting is immediate; if below 0.3, the comment is placed at the end of the posting queue, applying threshold-based control logic. Furthermore, if a new important comment is generated while waiting to post, the posting unit recalculates priority and dynamically optimizes posting order. The output of the AI model is passed to the posting queue management module and used to optimize the order and timing of posting requests. These processes realize dynamic priority optimization by multidimensional feature analysis using AI, unlike conventional static posting order or simple chronological posting. The technical effects include rapid dissemination of information for important discussions or influential topics, and prevention of flooding of redundant information for less important topics, contributing to optimization of system-wide computational resources and communication bandwidth. It also improves user experience quality, discussion efficiency, and suppresses misunderstanding and information overload. Specific application fields include breaking news comment posting for news sites, corporate knowledge sharing systems, question and answer support in educational settings, and topic-based posting optimization in SNS, applicable to various environments where information dissemination according to importance is required.

The posting unit can apply different posting methods based on the category of comments at the time of posting. The posting unit may set specific criteria to classify the category of comments. For example, the posting unit classifies comments into categories such as political comments, technical comments, and social comments. The posting unit applies different posting methods based on the category of comments. For example, for political comments, the posting unit posts carefully. For technical comments, the posting unit may post quickly. For social comments, the posting unit may post with consideration for emotion. For example, for political comments, the posting unit posts carefully; for technical comments, the posting unit posts quickly. By applying posting methods according to the category of comments, the posting unit can post comments appropriately. Some or all of the above-described processing in the posting unit may be performed using AI or without using AI. For example, the posting unit may use an AI model to classify the category of comments and apply different posting methods. Specifically, the posting unit receives as input the comment text passed from the generation unit (e.g., “This policy has problems,” “New technology has been introduced,” “The happiness of society as a whole is important”). The posting unit inputs these comments into a BERT or Transformer-based sentence embedding model to generate a 768-dimensional vector representation. Next, the posting unit inputs these vectors into a category classification AI model (e.g., multi-class classifier or classifier with self-attention mechanism), which outputs category labels (e.g., politics, technology, society, economy, education) and category confidence scores (e.g., politics 0.9, technology 0.1, society 0.0). Examples of input include a comment such as “This policy has problems” with a politics category score of 0.95, or “New technology has been introduced” with a technology category score of 0.98. The posting unit executes a posting method selection logic according to the category label. For example, for the politics category, “insert additional verification/approval flow before posting”; for the technology category, “immediate automatic posting”; for the society category, “emphasize display reflecting sentiment analysis results,” dynamically switching between multiple posting flows or display templates. The output of the AI model is passed to the posting management module and used to optimize the order and timing of posting requests and display methods. Furthermore, the posting unit monitors post-reaction for each category (e.g., number of views, number of comments, number of reports) and optimizes posting methods by feedback. These processes realize category-adaptive posting optimization by multidimensional feature analysis using AI, unlike conventional single posting flow or static template posting. The technical effects include optimal selection of posting methods according to the characteristics of each category and discussion context, improving user experience quality, enhancing diversity and expertise of discussions, and reducing misunderstanding and risk of flaming. Collaboration with domain-specific posting flows also improves overall system posting accuracy and reliability. Specific application fields include category-specific posting management for news sites, corporate knowledge sharing systems, domain-specific question and answer support in educational settings, and topic-based posting optimization in SNS, applicable to various environments where category-adaptive information dissemination is required.

The posting unit can estimate a user's emotion and adjust the display method of posted comments based on the estimated emotion of the user. The posting unit may use facial recognition technology to estimate a user's emotion. For example, the posting unit analyzes facial data of the user captured by a camera to estimate emotion. The posting unit may also use text analysis technology to estimate emotion from the content of the user's comments. For example, the posting unit analyzes keywords or phrases contained in the user's comments and calculates an emotion score. Furthermore, the posting unit may use voice analysis technology to estimate emotion from the user's voice data. For example, the posting unit analyzes the tone and speed of the user's voice and calculates an emotion score. The posting unit adjusts the display method of posted comments based on the estimated emotion of the user. For example, if the user is angry, the posting unit displays calm comments prominently. If the user is relaxed, the posting unit may display friendly comments prominently. If the user is sad, the posting unit may display encouraging comments prominently. By adjusting the display method of comments according to the user's emotion, the posting unit can post comments with an appropriate display method. Emotion estimation is realized using, for example, an emotion engine or a generative AI with emotion estimation functions. Generative AI may be a text generation AI (e.g., LLM) or a multimodal generative AI, but is not limited to such examples. Specifically, the posting unit combines multiple modality inputs (image, text, voice) for user emotion estimation. For facial recognition, image tensor data obtained from a camera (e.g., 224×224×3 RGB image) is input into a CNN-based facial classification model to obtain a probability distribution of emotion labels such as “anger,” “joy,” and “sadness” (e.g., softmax output). Examples of input include images of angry faces, smiling faces, and crying faces. For text analysis, the user's comment text (e.g., “I'm really angry,” “I'm happy today”) is input into a BERT-based sentence embedding model to obtain a 768-dimensional vector, and an emotion classifier calculates emotion scores (e.g., anger 0.8, joy 0.1, sadness 0.1). For voice analysis, voice waveform data (e.g., 16 kHz sampling, 3-second audio clip) is input into an RNN or Transformer-based voice emotion recognition model after MFCC feature extraction, and outputs emotion labels and confidence scores. These multiple emotion estimation results are integrated using ensemble methods or weighted averages to obtain a final emotion estimation value (e.g., anger 0.7, joy 0.2, sadness 0.1). The posting unit executes a display method control algorithm based on this emotion estimation value. For example, if the anger score is 0.6 or higher, “display calm comments at the top”; if the sadness score is 0.7 or higher, “emphasize comments containing encouragement or empathy,” dynamically switching display templates and emphasis levels. The output of the AI model is passed to the display management module and used to optimize the layout, highlight processing, and display order in the comment section. Furthermore, if the user's emotional state changes, the posting unit may re-estimate emotion and dynamically readjust the display method. These processes realize dynamic display optimization according to user state, unlike conventional static display order or simple automatic display. The technical effects include prevention of inappropriate display or misunderstanding during emotional peaks, and significant improvement in user experience quality and communication health. The combination of AI-based multimodal emotion estimation and display control enables individually optimized display that was previously difficult. Specific application fields include real-time comment display optimization in live streaming services, emphasis of empathetic responses in online counseling, and student support in educational settings, widely applicable to emotion-adaptive communication support environments.

The posting unit can perform posting by considering the geographic distribution of comments at the time of posting. The posting unit may set specific criteria to consider the geographic distribution of comments. For example, the posting unit classifies comments as related to specific regions or geographically biased. The posting unit performs posting based on the geographic distribution of comments. For example, the posting unit preferentially posts comments related to specific regions. Geographically biased comments may be postponed. Furthermore, the posting unit may appropriately post comments related to specific regions by considering geographic distribution. For example, the posting unit preferentially posts comments related to events held in specific regions. By considering the geographic distribution of comments, the posting unit can post comments related to appropriate regions. Some or all of the above-described processing in the posting unit may be performed using AI or without using AI. For example, the posting unit may use an AI model to analyze the geographic distribution of comments and perform posting. Specifically, the posting unit receives the comment text passed from the generation unit along with the poster's geographic location information (e.g., latitude and longitude pair from GPS data, region label estimated from IP address). The posting unit integrates these as multidimensional feature vectors (e.g., location information vector+text embedding vector) and inputs them into a geographic relevance evaluation AI model (e.g., multilayer perceptron or classifier with attention mechanism). The AI model outputs region relevance score (e.g., 0.0 to 1.0), event relevance score (e.g., 0.0 to 1.0). Examples of input include “latitude 35.6895, longitude 139.6917, comment: I attended an event in Shibuya” or “IP address 203.0.113.1, comment: I'm interested in the weather in Hokkaido.” The output of the AI model is passed to the posting priority control logic, and posting order is optimized according to geographic distribution (e.g., immediate posting if region relevance score is 0.7 or higher, placement at the end of the posting queue if below 0.3). Furthermore, when multiple regions or events are simultaneously related, weighted scoring or event priority rules may be applied. These processes realize dynamic region/event relevance optimization by high-dimensional feature analysis using AI, unlike conventional simple region name matching or manual selection. The technical effects include efficient posting of comments with high regionality or event relevance, greatly improving the comprehensiveness and immediacy of information in region-limited services, event management support, and disaster site information dissemination. Specific application fields include regional community sites, tourism information platforms, disaster information sharing systems, and event management support tools, applicable to comment posting environments where geographic context is important.

The posting unit can improve the accuracy of posting by referring to related literature of comments at the time of posting. For example, the posting unit sets specific criteria to refer to related literature of comments. The posting unit collects literature related to the content of comments and generates comments containing accurate information. The posting unit improves posting accuracy based on related literature of comments. For example, the posting unit refers to literature related to the content of comments and posts comments containing accurate information. Additionally, the posting unit can appropriately post comments related to specific topics based on related literature. Furthermore, the posting unit can refer to related literature to supplement the content of comments when posting. For example, the posting unit cites literature related to the content of comments to provide accurate information. Thus, by referring to related literature of comments, the posting unit can post comments containing accurate information. Some or all of the above-described processing in the posting unit may be performed using AI or without using AI. For example, the posting unit can use an AI model for referring to related literature of comments when posting. Specifically, the posting unit receives as input the comment text passed from the generation unit (e.g., “This policy contributes to economic growth”) and a related literature database (e.g., structured data including paper titles, abstracts, publication years, authors, DOIs, etc.). The posting unit uses BERT or Transformer-based sentence embedding models to vectorize both the comment text and literature abstracts, and calculates a relevance score (e.g., 0.0 to 1.0) using cosine similarity or attention mechanisms. Example inputs include “Comment: This policy contributes to economic growth” and “Literature: Relationship between economic policy and growth rate (2022)”. The AI model output automatically selects literature with high relevance scores and passes it to a supplementation algorithm that adds citation information (e.g., source, abstract, link) to the comment. For example, literature with a relevance score of 0.8 or higher is automatically appended to the end of the comment as “Reference: Relationship between economic policy and growth rate (2022)”. Furthermore, the posting unit considers the reliability and recency of citation information (e.g., publication year, citation count) and executes posting accuracy optimization logic. These processes, unlike conventional manual citation or static information supplementation, realize multidimensional feature analysis and dynamic literature reference optimization by AI. The technical effect is that comments containing accurate and highly reliable information can be posted, suppressing the spread of misinformation and misunderstanding, and greatly improving the quality and reliability of discussions. Specific application fields include posting explanatory comments on news sites, knowledge sharing systems within companies, question-and-answer with references in educational settings, and fact-checking support on social media, making it applicable to various environments where information accuracy is important.

The system according to the embodiment is not limited to the above examples and can be variously modified as described below. Specifically, the system can flexibly change the internal algorithms, data flows, AI model architectures, input/output data formats, control logic, and feature or parameter settings of each component such as the collection unit, detection unit, generation unit, and posting unit. For example, in the collection unit, not only web scraping and API integration for obtaining comment data, but also real-time streaming data ingestion, batch acquisition from distributed databases, and collection of audio/image data from IoT devices can be implemented. In the detection unit, in addition to natural language processing models such as BERT and Transformer-based models, CNNs, RNNs, graph neural networks, and self-supervised learning models can be combined and used. The detection unit can introduce advanced analysis methods such as multi-class classification, multi-label classification, anomaly detection, clustering, and time-series prediction, not just binary classification. In the generation unit, not only text generation AI (large language models) but also image generation models, speech synthesis models, and multimodal generation models can be linked to enhance response diversity and expressiveness. For example, the generation unit can input a combination of user attributes, emotional states, comment context, posting history, geographic information, and related literature information as prompts to generate individually optimized responses. In the posting unit, not only posting via API but also broadcasting to distributed networks, simultaneous posting to multiple platforms, A/B testing before and after posting, and posting strategy optimization through reaction analysis and feedback loops after posting can be implemented. Furthermore, the system can adopt various learning methods for AI models in each unit, such as supervised learning, semi-supervised learning, self-supervised learning, reinforcement learning, transfer learning, and federated learning. These modifications enable the system to be flexibly and dynamically configured and optimized according to the environment, purpose, user attributes, and operational policies, unlike conventional static and single-function systems. For example, the system can realize optimal comment collection, analysis, generation, and posting flows for various use cases such as live streaming services, social media, online education, internal corporate communication, disaster information sharing, and brand monitoring. As a result, the system's scalability, adaptability, operational efficiency, and user experience quality are greatly improved, contributing to the soundness of information distribution and the enhancement of diversity and reliability in discussions.

The collection unit can analyze a user's browsing history and preferentially collect related comments. For example, the collection unit analyzes websites and content previously visited by the user and preferentially collects comments related to relevant topics. The collection unit can also preferentially collect comments related to websites frequently visited by the user. Furthermore, the collection unit can collect comments related to specific interests or concerns based on the user's browsing history. By considering the user's browsing history, the collection unit can preferentially collect highly relevant comments. Specifically, the collection unit obtains the user's browsing history data (e.g., structured data including URL lists, page titles, browsing times, duration of stay, category labels), and preprocesses it as time-series vectors or category distribution vectors. The collection unit uses AI models such as BERT or Transformer-based text embedding models to vectorize the content of each browsed page and generate a user interest profile (e.g., topic distribution vector, interest score). Example inputs include “URL: example.com/news/tech, Title: Latest trends in AI technology, Browsing time: 2024 Jun. 1 10:00” and “URL: example.com/sports, Title: Japan national soccer team, Browsing time: 2024 Jun. 1 11:00”. The collection unit calculates cosine similarity or attention scores between these profiles and each comment in the comment database (e.g., text embedding vectors with topic labels), and computes relevance scores (e.g., 0.0 to 1.0). The AI model output includes relevance scores and priority labels (e.g., high/medium/low) for each comment, and applies priority control logic (e.g., preferentially collecting comments with relevance scores of 0.7 or higher). Additionally, comments related to topics with high browsing frequency or long duration are weighted higher, while comments related to temporary or low-interest topics are given lower priority. These processes, unlike conventional simple keyword matching or static topic matching, realize multidimensional feature analysis and dynamic relevance optimization by AI. The technical effect is that comments tailored to the user's interests and concerns can be efficiently collected, contributing to improved user experience, activation of discussions, personalization of information, and optimization of system-wide computational resources. Specific application fields include personalized comment collection for news sites, review collection for e-commerce sites, learning history-linked comment collection for educational platforms, and knowledge sharing systems within companies, making it widely applicable to information collection environments utilizing user behavior history.

The collection unit can estimate a user's emotion and adjust the content of comments to be collected based on the estimated emotion. For example, if the user is angry, the collection unit preferentially collects calm comments. If the user is relaxed, the collection unit can preferentially collect friendly comments. Furthermore, if the user is sad, the collection unit can preferentially collect encouraging comments. By adjusting the content of comments to be collected according to the user's emotion, the collection unit can collect appropriate comments. Specifically, the collection unit combines multiple modality inputs (images, text, audio) for emotion estimation. For facial expression recognition, image tensors obtained from a camera (e.g., 224×224×3 RGB images) are input to a CNN-based facial expression classification model to obtain probability distributions of emotion labels such as “anger,” “joy,” and “sadness” (e.g., softmax output). Example inputs include images of angry faces, smiling faces, and crying faces. For text analysis, the user's comment text (e.g., “I'm really angry,” “Today is fun”) is input to a BERT-based sentence embedding model to obtain a 768-dimensional vector, and an emotion classifier calculates emotion scores (e.g., anger 0.8, joy 0.1, sadness 0.1). For audio analysis, audio waveform data (e.g., 16 kHz sampling, 3-second audio clips) are processed for MFCC feature extraction and input to an RNN or Transformer-based speech emotion recognition model, which outputs emotion labels and confidence scores. These multiple emotion estimation results are integrated using ensemble methods or weighted averages to obtain a final emotion estimation value (e.g., anger 0.7, joy 0.2, sadness 0.1). Based on this emotion estimation value, the collection unit executes a comment content control algorithm. For example, if the anger score is 0.6 or higher, only calm comments are preferentially collected; if the sadness score is 0.7 or higher, comments containing encouragement or empathy are preferentially collected, and so on, dynamically switching the selection logic for comments to be collected. The AI model output includes emotion suitability scores and priority labels (e.g., calm/friendly/encouraging) for each comment, and these are used to reorder or filter the collection queue. These processes, unlike conventional static comment collection or simple keyword filtering, realize dynamic content optimization according to user state. The technical effect is that inappropriate comments or misunderstandings during emotional peaks can be prevented, greatly improving the quality of user experience and the soundness of communication. Furthermore, the combination of multimodal emotion estimation and content control by AI enables individually optimized collection that was previously difficult. Specific application fields include real-time comment collection for live streaming services, emotion-adaptive comment collection for online counseling, and student reaction monitoring in educational settings, making it widely applicable to emotion-adaptive communication support environments.

The detection unit can analyze the social media activity of comment posters and adjust the criteria for detecting non-constructive comments. For example, if the poster frequently posts aggressive comments on social media, the detection criteria are made stricter. If the poster frequently posts constructive comments, the detection criteria can be relaxed. Furthermore, based on the poster's social media activity, the detection unit can detect non-constructive comments related to specific topics. By considering the poster's social media activity, the detection unit can more accurately detect non-constructive comments. Specifically, the detection unit collects the poster's social media activity data (e.g., structured data including post text, posting frequency, engagement count, follower count, topic labels) and vectorizes it using BERT or Transformer-based text embedding models. The detection unit summarizes these vectors as time-series arrays or statistical features (e.g., time-series of aggressiveness scores, average constructiveness score) to generate a poster profile. Example inputs include “text of the last 30 posts,” “number of posts containing aggressive expressions,” and “follower count 10,000.” The detection unit simultaneously inputs the poster profile and current comment text embedding to an AI model (e.g., attribute-conditioned text classification model), which outputs non-constructiveness scores (e.g., 0.0 to 1.0), aggressiveness scores, and topic-related risk scores. The AI model output is passed to detection criteria control logic (e.g., stricter judgment for posters with past aggressiveness scores of 0.7 or higher, relaxed for constructiveness scores of 0.8 or higher), dynamically adjusting detection thresholds and judgment criteria. Additionally, posting tendencies for specific topics (e.g., frequent aggressive posts in the political category lead to stricter criteria for that topic) can be considered. These processes, unlike conventional simple text analysis or static rule-based detection, realize dynamic detection optimization by integrating poster attributes, history, and posting tendencies multidimensionally. The technical effect is that the accuracy of detecting attribute discrimination and prejudice is greatly improved, and the oversight of aggressive remarks or harassment toward specific attributes is reduced. Furthermore, dynamic optimization of detection criteria based on attribute information enhances the overall soundness and fairness of the system. Specific application fields include social media-linked comment monitoring, brand monitoring, bullying detection in educational settings, and internal corporate communication monitoring, making it widely applicable to comment analysis environments with high attribute dependency.

The detection unit can estimate a user's emotion and adjust the criteria for detecting non-constructive comments based on the estimated emotion. For example, if the user is angry, the detection unit makes the criteria for detecting aggressive comments stricter. If the user is relaxed, the detection criteria can be relaxed. Furthermore, if the user is sad, the detection unit can adjust the criteria for detecting emotional comments. By adjusting the detection criteria according to the user's emotion, the detection unit can more accurately detect non-constructive comments. Specifically, the detection unit combines multiple modality inputs (images, text, audio) for emotion estimation. For facial expression recognition, image tensors obtained from a camera (e.g., 224×224×3 RGB images) are input to a CNN-based facial expression classification model to obtain probability distributions of emotion labels such as “anger,” “joy,” and “sadness” (e.g., softmax output). Example inputs include images of angry faces, smiling faces, and crying faces. For text analysis, the user's comment text (e.g., “I'm really angry,” “Today is fun”) is input to a BERT-based sentence embedding model to obtain a 768-dimensional vector, and an emotion classifier calculates emotion scores (e.g., anger 0.8, joy 0.1, sadness 0.1). For audio analysis, audio waveform data (e.g., 16 kHz sampling, 3-second audio clips) are processed for MFCC feature extraction and input to an RNN or Transformer-based speech emotion recognition model, which outputs emotion labels and confidence scores. These multiple emotion estimation results are integrated using ensemble methods or weighted averages to obtain a final emotion estimation value (e.g., anger 0.7, joy 0.2, sadness 0.1). Based on this emotion estimation value, the detection unit executes detection criteria control algorithms. For example, if the anger score is 0.6 or higher, the detection threshold for aggressive expressions is set to 0.3; if the joy score is 0.8 or higher, the detection threshold is relaxed to 0.7, applying threshold-based control logic. The AI model output includes non-constructiveness scores, aggressiveness scores, and emotion suitability scores for each comment, and these are used to dynamically adjust detection judgments. These processes, unlike conventional simple keyword matching or static rule-based detection, realize dynamic optimization of detection criteria according to user state. The technical effect is that aggressive remarks during emotional peaks and balanced opinions in calm states can be detected with high accuracy, greatly reducing false detections and oversights. Furthermore, unnecessary detection processing and server load are reduced, contributing to overall system efficiency. Specific application fields include real-time comment monitoring for live streaming services, emotion monitoring in online counseling, and student speech management in educational settings, making it applicable to various user interaction environments.

The generation unit can estimate a user's emotion and adjust the content of comments to be generated based on the estimated emotion. For example, if the user is angry, the generation unit generates calm and constructive comments. If the user is relaxed, the generation unit can generate friendly comments. Furthermore, if the user is sad, the generation unit can generate encouraging comments. By adjusting the content of comments according to the user's emotion, the generation unit can generate appropriate comments. Specifically, the generation unit combines multiple modality inputs (images, text, audio) for emotion estimation. For facial expression recognition, image tensors obtained from a camera (e.g., 224×224×3 RGB images) are input to a CNN-based facial expression classification model to obtain probability distributions of emotion labels such as “anger,” “joy,” and “sadness” (e.g., softmax output). Example inputs include images of angry faces, smiling faces, and crying faces. For text analysis, the user's comment text (e.g., “I'm really angry,” “Today is fun”) is input to a BERT-based sentence embedding model to obtain a 768-dimensional vector, and an emotion classifier calculates emotion scores (e.g., anger 0.8, joy 0.1, sadness 0.1). For audio analysis, audio waveform data (e.g., 16 kHz sampling, 3-second audio clips) are processed for MFCC feature extraction and input to an RNN or Transformer-based speech emotion recognition model, which outputs emotion labels and confidence scores. These multiple emotion estimation results are integrated using ensemble methods or weighted averages to obtain a final emotion estimation value (e.g., anger 0.7, joy 0.2, sadness 0.1). Based on this emotion estimation value, the generation unit executes generation prompt control algorithms. For example, if the anger score is 0.6 or higher, the prompt template is dynamically switched to “respond with calm and constructive expressions”; if the sadness score is 0.7 or higher, “respond with expressions including encouragement or empathy,” and so on. The generation AI model (e.g., a Transformer-based LLM with billions of parameters or a multimodal generation model) receives attribute-attached prompts such as “User emotion: anger 0.8, comment: I'm really angry” as input and outputs natural language text tailored to the emotion (e.g., “Let's discuss calmly,” “I understand your feelings”) or, if necessary, response data in image or video format. Example outputs include “Let's exchange opinions calmly on this issue” and “We empathize with your feelings.” These outputs are passed to the subsequent posting unit and optimized in conjunction with posting timing and display methods. These processes, unlike conventional static template responses or simple automatic generation, realize dynamic content optimization according to user state. The technical effect is that inappropriate responses or misunderstandings during emotional peaks can be prevented, greatly improving the quality of user experience and the soundness of communication. Furthermore, the combination of multimodal emotion estimation and generation prompt control by AI enables individually optimized responses that were previously difficult. Specific application fields include real-time response generation for live streaming services, empathetic responses for online counseling, and student support in educational settings, making it widely applicable to emotion-adaptive communication support environments.

The generation unit can adjust the content of comments to be generated based on the context of comments at the time of generation. For example, the generation unit analyzes the preceding and following context of comments to generate appropriate responses. The generation unit can also consider background information of comments. For example, it collects background information related to specific topics and generates comments based on that information. Furthermore, the generation unit can use natural language processing technology to understand the context of comments. By considering the context and background information of comments, the generation unit can generate appropriate comments. Specifically, the generation unit obtains not only individual comments but also sequences of preceding and following comments or entire threads as time-series text arrays (e.g., each comment vectorized by BERT or Transformer-based sentence embedding, input as a sequence of up to 10 consecutive comments). The generation unit inputs this context information to a Transformer-type model with self-attention mechanisms to analyze the semantic relationships and flow of each comment in high-dimensional space. Example inputs include sequences of consecutive comments such as “A: This policy has problems B: I don't think so C: You are wrong” or “Flow of discussion on event A.” The generation unit adds topic metadata as background information (e.g., topic name under discussion, summary of related news articles, event occurrence time) as additional features and integrates them as multimodal input vectors. The generation AI model (e.g., a Transformer-based large language model with billions of parameters or a domain-specific submodel) receives attribute-attached prompts such as “Context: A→B→C, Topic: Economic policy” as input and outputs natural language text optimized for the context (e.g., “There are different positions in this discussion. Let's exchange opinions calmly”) or, if necessary, response data including charts or reference information. Example outputs include “There are pros and cons to this policy. In favor: . . . Against: . . . ” or “The background of event A includes the fact that . . . ”. These outputs are passed to the subsequent posting unit and optimized in conjunction with posting timing and display methods. These processes, unlike uniform generation by a single model or static template responses, realize multidimensional feature analysis and context-adaptive generation optimization by AI. The technical effect is that even expressions with the same wording can be accurately distinguished depending on the context (e.g., distinguishing between “sarcasm as a joke” and “aggressive criticism”), reducing misunderstandings and the risk of flaming, and improving the quality and reliability of discussions. Specific application fields include thread response generation for social media and bulletin boards, discussion management for online learning platforms, and harassment countermeasures in corporate chat, making it widely applicable to comment generation environments with high context dependency.

The generation unit can adjust the content of comments to be generated based on attribute information of the comment poster at the time of generation. For example, the generation unit considers attribute information such as the poster's age, gender, and occupation when generating comments. The generation unit can also analyze the poster's past comment history to generate appropriate responses. Furthermore, the generation unit can generate comments related to specific attributes. By considering the poster's attribute information, the generation unit can generate appropriate comments. Specifically, the generation unit constructs a user attribute database (e.g., structured data including user ID, age, gender, occupation, region, affiliated organization, past posting history, evaluation scores) and attaches poster attribute vectors (e.g., age category, gender one-hot, occupation category, embedding vectors of the last 30 comments) to each comment. The generation unit integrates these attribute information and comment text embeddings (e.g., 768-dimensional vectors from BERT or Transformer-based models) as multidimensional features and inputs them to a generation AI model (e.g., attribute-conditioned large language model). Example inputs include “User ID 123, age 25, male, engineer, comment: This opinion is unacceptable” and “User ID 456, age 60, female, teacher, comment: Young people don't understand.” The generation unit inputs past comment history as time-series vectors (e.g., array of BERT embeddings for the last 30 comments) to an LSTM or Transformer-based sequence generation model to calculate posting tendencies (e.g., constructiveness score, bias score, topic interest score) and reflect them in the response generation prompt. The output of the generation AI model is natural language text optimized for the poster's attributes and history (e.g., “From an engineer's perspective . . . ”, “Based on experience in education . . . ”) or, if necessary, response data including expressions and examples considerate of attributes. Example outputs include “Let's value the opinions of the younger generation” and “We appreciate your opinion as a technical expert.” These outputs are passed to the subsequent posting unit and optimized in conjunction with posting timing and display methods. These processes, unlike conventional simple template responses or static automatic generation, realize dynamic content optimization by multidimensionally integrating user attributes, history, and posting tendencies. The technical effect is that discrimination and bias based on attributes are suppressed, the quality of user experience is improved through individually optimized responses, and diversity and fairness in discussions are enhanced. Specific application fields include corporate communication support, student support in educational settings, and attribute-adaptive response generation for social media, making it widely applicable to comment generation environments with high attribute dependency.

The posting unit can estimate a user's emotion and adjust the content of comments to be posted based on the estimated emotion. For example, if the user is angry, the posting unit preferentially posts calm comments. If the user is relaxed, the posting unit can preferentially post friendly comments. Furthermore, if the user is sad, the posting unit can preferentially post encouraging comments. By adjusting the content of comments to be posted according to the user's emotion, the posting unit can post appropriate comments. Specifically, the posting unit combines multiple modality inputs (images, text, audio) for emotion estimation. For facial expression recognition, image tensors obtained from a camera (e.g., 224×224×3 RGB images) are input to a CNN-based facial expression classification model to obtain probability distributions of emotion labels such as “anger,” “joy,” and “sadness” (e.g., softmax output). Example inputs include images of angry faces, smiling faces, and crying faces. For text analysis, the user's comment text (e.g., “I'm really angry,” “Today is fun”) is input to a BERT-based sentence embedding model to obtain a 768-dimensional vector, and an emotion classifier calculates emotion scores (e.g., anger 0.8, joy 0.1, sadness 0.1). For audio analysis, audio waveform data (e.g., 16 kHz sampling, 3-second audio clips) are processed for MFCC feature extraction and input to an RNN or Transformer-based speech emotion recognition model, which outputs emotion labels and confidence scores. These multiple emotion estimation results are integrated using ensemble methods or weighted averages to obtain a final emotion estimation value (e.g., anger 0.7, joy 0.2, sadness 0.1). Based on this emotion estimation value, the posting unit executes posting content control algorithms. For example, if the anger score is 0.6 or higher, only calm comments are preferentially posted; if the sadness score is 0.7 or higher, comments containing encouragement or empathy are preferentially posted, and so on, dynamically switching the selection logic for comments to be posted. The AI model output includes emotion suitability scores and priority labels (e.g., calm/friendly/encouraging) for each comment, and these are used to reorder or filter the posting queue. These processes, unlike conventional static posting or simple keyword filtering, realize dynamic content optimization according to user state. The technical effect is that inappropriate postings or misunderstandings during emotional peaks can be prevented, greatly improving the quality of user experience and the soundness of communication. Furthermore, the combination of multimodal emotion estimation and posting content control by AI enables individually optimized posting that was previously difficult. Specific application fields include real-time posting for live streaming services, emotion-adaptive posting for online counseling, and student support in educational settings, making it widely applicable to emotion-adaptive communication support environments.

The posting unit can analyze the social media activity of comment posters at the time of posting and determine the priority of posting. For example, if the poster is frequently active on social media, the posting unit preferentially posts their comments. If the poster is influential on social media, the posting unit can also preferentially post their comments. Furthermore, based on the poster's social media activity, the posting unit can preferentially post comments related to specific topics. By considering the poster's social media activity, the posting unit can preferentially make appropriate postings. Specifically, the posting unit collects the poster's social media activity data (e.g., structured data including posting frequency, engagement count, follower count, topic labels) and vectorizes it using BERT or Transformer-based text embedding models. The posting unit summarizes these vectors as time-series arrays or statistical features (e.g., time-series of engagement scores, average influence score) to generate a poster profile. Example inputs include “text of the last 30 posts,” “follower count 10,000,” and “engagement rate 0.2.” The posting unit simultaneously inputs the poster profile and posting comment text embedding to an AI model (e.g., posting priority classification model), which outputs posting priority scores (e.g., 0.0 to 1.0), influence scores, and topic relevance scores. The AI model output is passed to posting priority control logic (e.g., immediate posting for posters with influence scores of 0.8 or higher, priority posting for topic relevance of 0.7 or higher), which reorders the posting queue and optimizes posting timing. Additionally, posting tendencies for specific topics (e.g., prioritizing influential posters in the political category) can be considered. These processes, unlike conventional simple posting order or static priority settings, realize dynamic posting optimization by multidimensionally integrating poster attributes, history, and posting tendencies. The technical effect is that posts from influential posters or those highly relevant to topics can be efficiently disseminated, contributing to the activation of discussions, optimization of information diffusion, and maintenance of overall system soundness. Specific application fields include social media-linked posting management, brand monitoring, online community operation, and emphasis of expert statements in educational settings, making it widely applicable to posting environments with high attribute dependency.

The posting unit can consider the geographic location information of comment posters at the time of posting. For example, if the poster is in a specific region, the posting unit preferentially posts comments related to that region. If the poster is in a different region, the posting unit can postpone posting comments related to that region. Furthermore, based on the poster's geographic location information, the posting unit can preferentially post comments related to specific events. By considering the poster's geographic location information, the posting unit can post comments related to appropriate regions. Specifically, the posting unit obtains the poster's geographic location information (e.g., latitude and longitude pairs from GPS data, region labels estimated from IP addresses) and integrates it with the posting comment as a multidimensional feature vector (e.g., location information vector plus text embedding vector). The posting unit inputs these vectors to a geographic relevance evaluation AI model (e.g., multilayer perceptron or classifier with attention mechanism), which outputs region relevance scores (e.g., 0.0 to 1.0) and event relevance scores (e.g., 0.0 to 1.0). Example inputs include “Latitude 35.6895, Longitude 139.6917, Comment: I participated in an event in Shibuya” and “IP address 203.0.113.1, Comment: I'm interested in the weather in Hokkaido.” The AI model output is passed to posting priority control logic (e.g., immediate posting for region relevance scores of 0.7 or higher, placing in the back of the posting queue for scores below 0.3), which optimizes posting order according to geographic distribution. Furthermore, when multiple regions or events are simultaneously relevant, weighted scoring or event priority rules can be applied. These processes, unlike conventional simple region name matching or manual selection, realize high-dimensional feature analysis and dynamic region/event relevance optimization by AI. The technical effect is that comments with high regional or event relevance can be efficiently posted, greatly improving the comprehensiveness and immediacy of information in region-specific services, event management support, and disaster information dissemination. Specific application fields include regional community sites, tourism information platforms, disaster information sharing systems, and event management support tools, making it applicable to comment posting environments where geographic context is important.

Below is a brief explanation of the processing flow of Example of the Embodiment. Specifically, the system executes a series of data flows from comment data acquisition, analysis, response generation, to posting, through cooperation among the collection unit, detection unit, generation unit, and posting unit. First, in the collection unit, web scraping technology and API integration functions are utilized to acquire text comments as string arrays (e.g., “This opinion is one-sided”), image comments as image tensors (e.g., 224×224×3 RGB images), and video comments as sequences of video frames (e.g., 30 fps continuous images), and these are linked with posting time and poster attributes (e.g., user ID, age, region) and stored in a database. The collection unit performs preprocessing such as noise removal, normalization, and feature extraction (e.g., face detection, text normalization) on the collected data. The detection unit inputs the collected comment data to natural language processing algorithms (e.g., BERT-based context understanding models or Transformer architectures), tokenizes and vectorizes each comment (e.g., 768-dimensional sentence embedding vectors), and inputs them to pre-trained classification models (e.g., binary classifier for fairness judgment, multi-class classifier for non-constructiveness judgment). Example inputs include text data such as “You are wrong,” “This opinion is one-sided,” and image data containing aggressive facial expressions. The detection unit outputs a fairness score (e.g., continuous value from 0.0 to 1.0), a constructiveness label (e.g., constructive/non-constructive), and the underlying features (e.g., frequency of aggressive vocabulary, sentiment analysis score) for each comment. For example, for the comment “You are wrong,” a fairness score of 0.2 and a constructiveness label of “non-constructive” are output. These outputs are used in the subsequent generation unit, where threshold judgment (e.g., fairness score below 0.5, constructiveness label is non-constructive) selects comments as response generation targets. The generation unit inputs the comments and attribute information passed from the detection unit as prompts to large language models or multimodal generation models. Example inputs include “Generate a constructive opinion from a different perspective for this comment within 200 characters” or “Generate a response that encourages calm discussion for an aggressive comment.” The generation unit outputs natural language text (e.g., “There is another perspective on this issue . . . ”), and, if necessary, response data in image or video format. The generated comments are posted to the comment section via API by the posting unit. The posting unit automatically performs sending of posting requests, response analysis of posting results, and retry processing in case of posting failure. Through this series of processes, the system solves technical challenges that were previously difficult, such as high-dimensional feature extraction, multi-perspective generation, and real-time posting optimization by AI, surpassing simple human automation. The technical effect is that the diversity and constructiveness of discussions in the comment section are greatly improved, the spread of flaming and prejudice is suppressed, and a healthy communication space is realized. Specific application fields include news sites, social media, online learning platforms, and corporate communication tools, making it applicable to all user-generated content services.

Step 1: The collection unit collects contents of a comment section. The contents of the comment section include text comments, image comments, and video comments. The collection unit obtains comment data using web scraping technology or APIs. For example, web scraping technology is used to collect data from the comment section of a specific website. When using an API, the collection unit sends a request to obtain comment data and analyzes the data returned as a response. Step 2: The detection unit analyzes the comments collected by the collection unit and detects comments lacking fairness or non-constructive comments. The detection unit analyzes the content of comments using natural language processing technology. For example, a text analysis algorithm is used to detect specific keywords or phrases. Machine learning models can also be used to classify the content of comments. For example, comments containing prejudice or discrimination are detected by filtering comments containing specific keywords or phrases. When using machine learning models, the model is trained using training data to classify the content of comments. Step 3: The generation unit uses a generation AI to generate comments from another perspective or constructive comments for the comments detected by the detection unit. The generation unit uses text generation AI (e.g., LLM) to generate comments. For example, for comments biased toward a specific opinion, the generation unit generates comments presenting opinions from another perspective. For comments that attack others, the generation unit can generate comments that encourage constructive discussion. The generation unit inputs prompts such as “Please generate an opinion from another perspective for this comment” to the generation AI and obtains the generated comments. Step 4: The posting unit posts the comments generated by the generation unit to the comment section. The posting unit uses an API to post comments. It sends a request to post the generated comments to the comment section and analyzes the data returned as a response. Specifically, in Step 1, the system utilizes web scraping technology and API integration functions in the collection unit to acquire text comments as string arrays (e.g., “This opinion is one-sided”), image comments as image tensors (e.g., 224×224×3 RGB images), and video comments as sequences of video frames (e.g., 30 fps continuous images), and links these with posting time and poster attributes (e.g., user ID, age, region) to store in a database. The collection unit performs preprocessing such as noise removal, normalization, and feature extraction (e.g., face detection, text normalization) on the collected data. In Step 2, the detection unit inputs the collected comment data to natural language processing algorithms (e.g., BERT-based context understanding models or Transformer architectures), tokenizes and vectorizes each comment (e.g., 768-dimensional sentence embedding vectors), and inputs them to pre-trained classification models (e.g., binary classifier for fairness judgment, multi-class classifier for non-constructiveness judgment). Example inputs include text data such as “You are wrong,” “This opinion is one-sided,” and image data containing aggressive facial expressions. The detection unit outputs a fairness score (e.g., continuous value from 0.0 to 1.0), a constructiveness label (e.g., constructive/non-constructive), and the underlying features (e.g., frequency of aggressive vocabulary, sentiment analysis score) for each comment. For example, for the comment “You are wrong,” a fairness score of 0.2 and a constructiveness label of “non-constructive” are output. These outputs are used in the subsequent generation unit, where threshold judgment (e.g., fairness score below 0.5, constructiveness label is non-constructive) selects comments as response generation targets. In Step 3, the generation unit inputs the comments and attribute information passed from the detection unit as prompts to large language models or multimodal generation models. Example inputs include “Generate a constructive opinion from a different perspective for this comment within 200 characters” or “Generate a response that encourages calm discussion for an aggressive comment.” The generation unit outputs natural language text (e.g., “There is another perspective on this issue . . . ”), and, if necessary, response data in image or video format. The generated comments are posted to the comment section via API by the posting unit in Step 4. The posting unit automatically performs sending of posting requests, response analysis of posting results, and retry processing in case of posting failure. Through this series of processes, the system solves technical challenges that were previously difficult, such as high-dimensional feature extraction, multi-perspective generation, and real-time posting optimization by AI, surpassing simple human automation. The technical effect is that the diversity and constructiveness of discussions in the comment section are greatly improved, the spread of flaming and prejudice is suppressed, and a healthy communication space is realized. Specific application fields include news sites, social media, online learning platforms, and corporate communication tools, making it applicable to all user-generated content services.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, detection unit, generation unit, and posting unit is implemented by at least one of, for example, a smart device 14 and a data processing apparatus 12. For example, the collection unit is implemented by a control unit 46A of the smart device 14 and collects contents of a comment section. The detection unit is implemented, for example, by a specific processing unit 290 of the data processing apparatus 12 and analyzes the collected comments to detect comments lacking fairness or non-constructive comments. The generation unit is implemented, for example, by the specific processing unit 290 of the data processing apparatus 12 and generates appropriate responses using a generation AI. The posting unit is implemented, for example, by the control unit 46A of the smart device 14 and posts the generated comments to the comment section. The correspondence between each unit and the device or control unit is not limited to the above examples and various modifications are possible.

### Second Embodiment

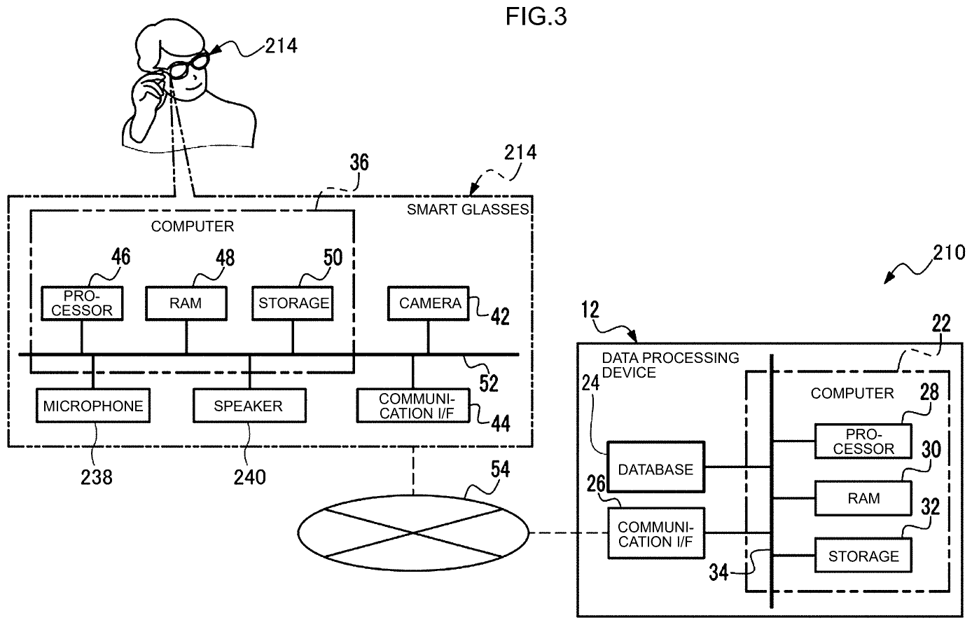

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

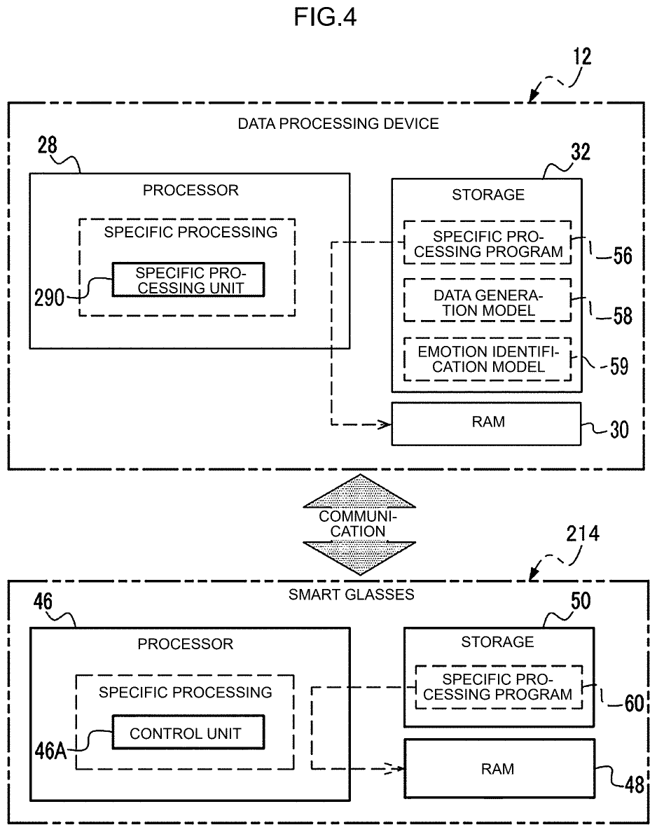

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, detection unit, generation unit, and posting unit is implemented by at least one of, for example, smart glasses 214 and a data processing apparatus 12. For example, the collection unit is implemented by a control unit 46A of the smart glasses 214 and collects contents of a comment section. The detection unit is implemented, for example, by a specific processing unit 290 of the data processing apparatus 12 and analyzes the collected comments to detect comments lacking fairness or non-constructive comments. The generation unit is implemented, for example, by the specific processing unit 290 of the data processing apparatus 12 and generates appropriate responses using a generation AI. The posting unit is implemented, for example, by the control unit 46A of the smart glasses 214 and posts the generated comments to the comment section. The correspondence between each unit and the device or control unit is not limited to the above examples and various modifications are possible.

### Third Embodiment

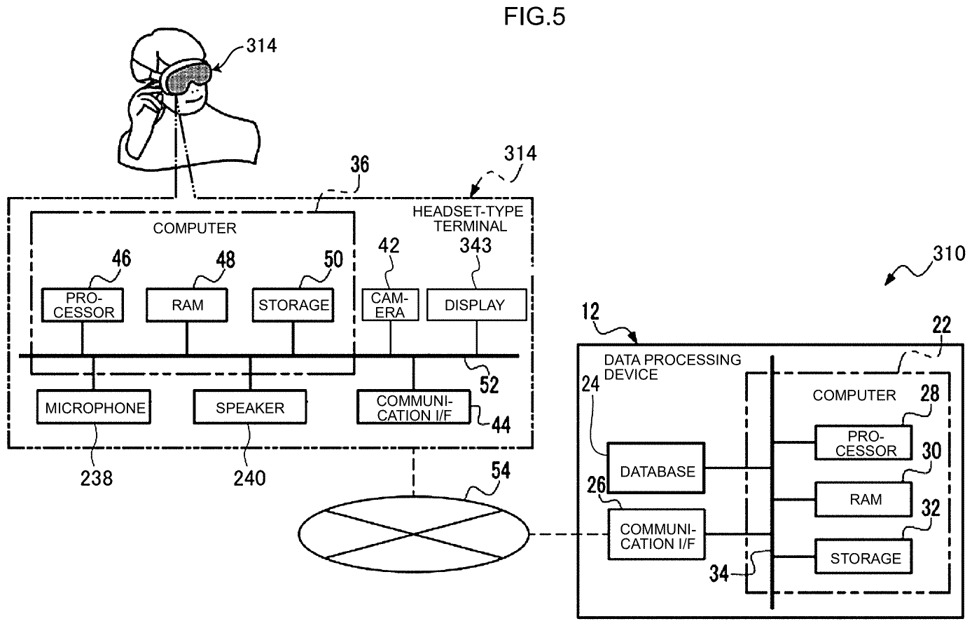

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

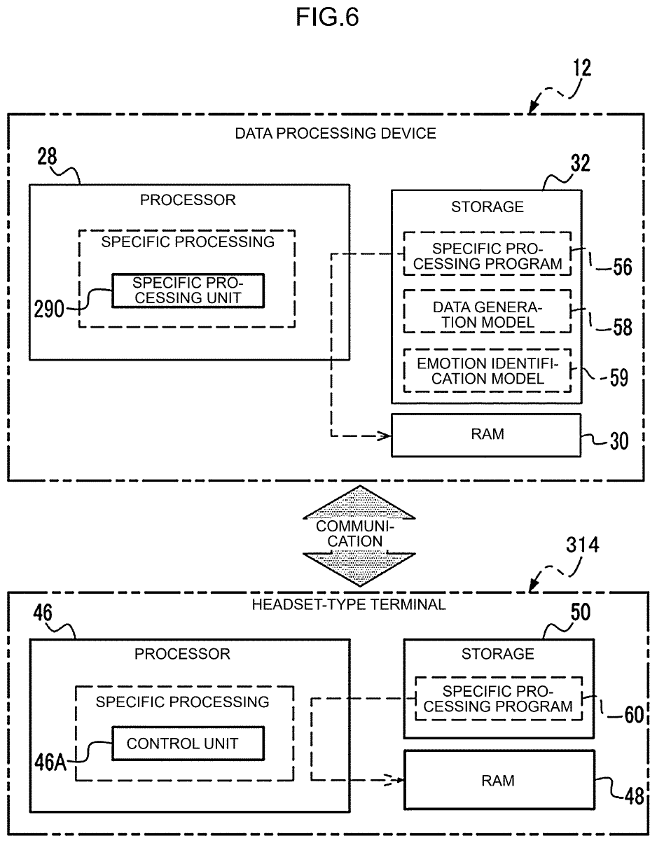

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, detection unit, generation unit, and posting unit is implemented by at least one of, for example, a headset-type terminal 314 and a data processing apparatus 12. For example, the collection unit is implemented by a control unit 46A of the headset-type terminal 314 and collects contents of a comment section. The detection unit is implemented, for example, by a specific processing unit 290 of the data processing apparatus 12 and analyzes the collected comments to detect comments lacking fairness or non-constructive comments. The generation unit is implemented, for example, by the specific processing unit 290 of the data processing apparatus 12 and generates appropriate responses using a generation AI. The posting unit is implemented, for example, by the control unit 46A of the headset-type terminal 314 and posts the generated comments to the comment section. The correspondence between each unit and the device or control unit is not limited to the above examples and various modifications are possible.

### Fourth Embodiment

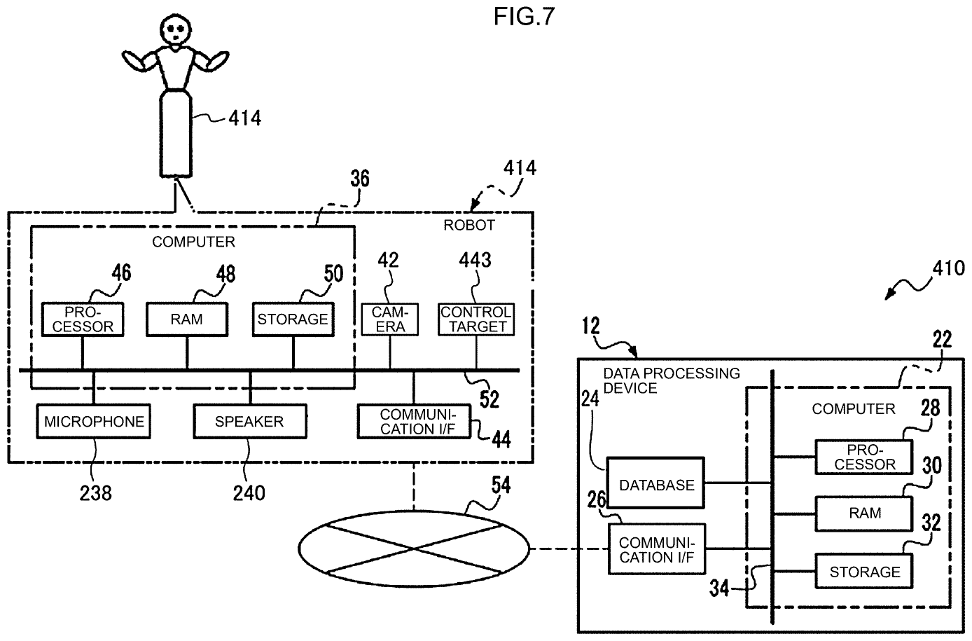

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

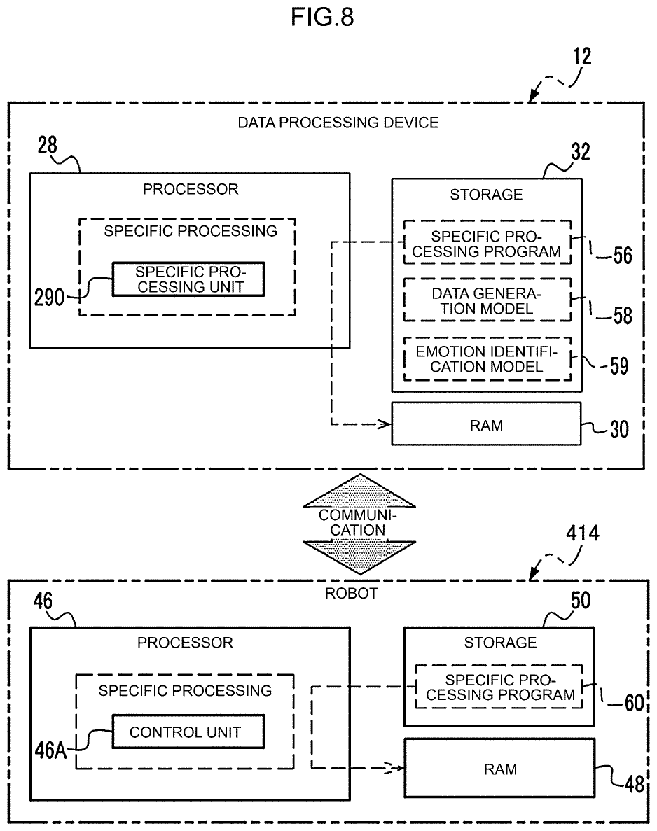

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, detection unit, generation unit, and posting unit is implemented by at least one of, for example, a robot 414 and a data processing apparatus 12. For example, the collection unit is implemented by a control unit 46A of the robot 414 and collects contents of a comment section. The detection unit is implemented, for example, by a specific processing unit 290 of the data processing apparatus 12 and analyzes the collected comments to detect comments lacking fairness or non-constructive comments. The generation unit is implemented, for example, by the specific processing unit 290 of the data processing apparatus 12 and generates appropriate responses using a generation AI. The posting unit is implemented, for example, by the control unit 46A of the robot 414 and posts the generated comments to the comment section. The correspondence between each unit and the device or control unit is not limited to the above examples and various modifications are possible.

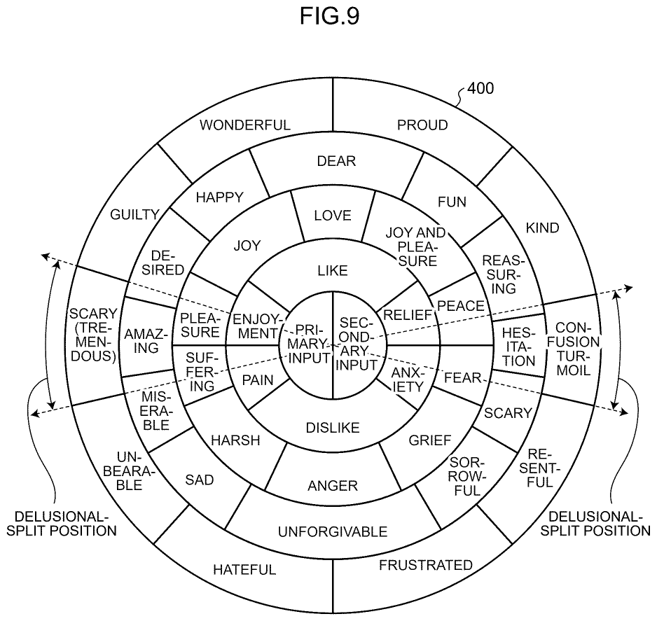

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

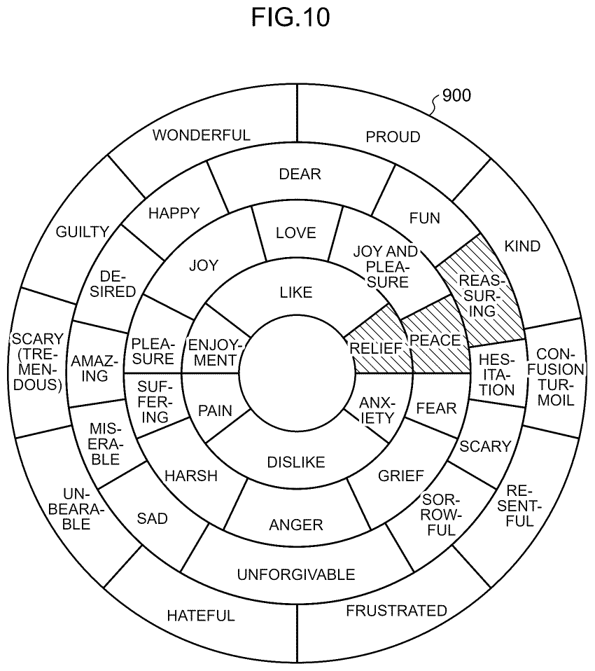

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### (Supplementary Note 1)

A system comprising: a collection unit configured to collect contents of a comment section; a detection unit configured to analyze comments collected by the collection unit and detect comments lacking fairness or non-constructive comments; a generation unit configured to generate comments from another perspective or constructive comments for the comments detected by the detection unit; and a posting unit configured to post the comments generated by the generation unit.

### (Supplementary Note 2)

The system according to Supplementary Note 1, wherein the collection unit is configured to estimate a user's emotion and adjust the timing of comment collection based on the estimated emotion of the user.

### (Supplementary Note 3)

The system according to Supplementary Note 1, wherein the collection unit is configured to perform filtering based on specific keywords or phrases at the time of comment collection.

### (Supplementary Note 4)

The system according to Supplementary Note 1, wherein the collection unit is configured to analyze a user's past comment history at the time of comment collection and determine the priority of comments to be collected.

### (Supplementary Note 5)

The system according to Supplementary Note 1, wherein the collection unit is configured to estimate a user's emotion and determine the priority of comments to be collected based on the estimated emotion of the user.

### (Supplementary Note 6)

The system according to Supplementary Note 1, wherein the collection unit is configured to preferentially collect highly relevant comments based on the user's geographic location information at the time of comment collection.

### (Supplementary Note 7)

The system according to Supplementary Note 1, wherein the collection unit is configured to analyze a user's social media activity at the time of comment collection and collect related comments.

### (Supplementary Note 8)

The system according to Supplementary Note 1, wherein the detection unit is configured to estimate a user's emotion and adjust the criteria for detecting comments lacking fairness or non-constructive comments based on the estimated emotion of the user.

### (Supplementary Note 9)

The system according to Supplementary Note 1, wherein the detection unit is configured to improve detection accuracy by considering the context or background information of comments at the time of detection.

### (Supplementary Note 10)

The system according to Supplementary Note 1, wherein the detection unit is configured to perform detection based on attribute information of the comment poster at the time of detection.

### (Supplementary Note 11)

The system according to Supplementary Note 1, wherein the generation unit is configured to estimate a user's emotion and adjust the expression method of generated comments based on the estimated emotion of the user.

### (Supplementary Note 12)

The system according to Supplementary Note 1, wherein the generation unit is configured to adjust the level of detail of generated comments based on the importance of the comments at the time of generation.

### (Supplementary Note 13)

The system according to Supplementary Note 1, wherein the generation unit is configured to apply different generation algorithms based on the category of comments at the time of generation.

### (Supplementary Note 14)

The system according to Supplementary Note 1, wherein the posting unit is configured to estimate a user's emotion and adjust the timing of posting comments based on the estimated emotion of the user.

### (Supplementary Note 15)

The system according to Supplementary Note 1, wherein the posting unit is configured to determine the priority of posting based on the contents of comments at the time of posting.

### (Supplementary Note 16)

The system according to Supplementary Note 1, wherein the posting unit is configured to apply different posting methods based on the category of comments at the time of posting.

### (Supplementary Note 17)

The system according to Supplementary Note 1, wherein the posting unit is configured to estimate a user's emotion and adjust the display method of posted comments based on the estimated emotion of the user.

### (Supplementary Note 18)

The system according to Supplementary Note 1, wherein the posting unit is configured to perform posting based on the geographic distribution of comments at the time of posting.

### (Supplementary Note 19)

The system according to Supplementary Note 1, wherein the posting unit is configured to improve posting accuracy based on related literature of comments at the time of posting.

What is claimed is:

1. A system comprising:
circuitry configured to:
acquire, from a data source communicatively coupled to the system via a packet-switched network, a set of text data records;
generate, by inputting each text data record of the set into a Transformer-based sentence embedding model, a respective multidimensional feature vector for each text data record;
generate, by inputting the respective multidimensional feature vectors into a trained classification model, a classification score for each text data record, the classification score indicating a degree to which the text data record satisfies a predefined criterion;
select, based on the classification scores, a subset of the text data records having classification scores that satisfy a threshold condition;
generate, by inputting the subset and associated attribute data into a data generation model, response data for each text data record of the subset; and
transmit, to the data source via the packet-switched network, the response data.

2. The system according to claim 1, wherein the set of text data records comprises contents of a comment section of a networked service, each text data record comprises a comment posted by a user, and the response data comprises a generated comment presenting an alternative perspective or a constructive response to a respective text data record of the subset.

3. The system according to claim 2, wherein the predefined criterion comprises at least one of a fairness criterion or a constructiveness criterion, the classification score comprises a fairness score indicating a degree to which the comment lacks fairness and a constructiveness label indicating whether the comment is constructive or non-constructive, and the threshold condition is satisfied when the fairness score is below a fairness threshold or the constructiveness label indicates non-constructive.

4. The system according to claim 1, wherein the Transformer-based sentence embedding model generates, for each text data record, a 768-dimensional sentence embedding vector by tokenizing the text data record and applying a self-attention mechanism to the tokenized text data record.

5. The system according to claim 1, wherein the circuitry is further configured to estimate an emotion of a user by inputting multimodal input data into an emotion identification model, the multimodal input data comprising at least two of image data captured by a camera, voice waveform data captured by a microphone, or text input data, and to adjust a timing of acquiring the set of text data records based on the estimated emotion.

6. The system according to claim 5, wherein the emotion identification model comprises a convolutional neural network configured to receive image data of a facial expression as an image tensor and output a probability distribution of emotion labels, a recurrent neural network configured to receive voice waveform data after mel-frequency cepstral coefficient feature extraction and output emotion labels with confidence scores, and a text classifier configured to receive the text input data and output emotion scores, and the circuitry integrates outputs of the convolutional neural network, the recurrent neural network, and the text classifier to generate a final emotion estimation value.

7. The system according to claim 1, wherein the circuitry is further configured to filter the set of text data records based on a keyword dictionary or a phrase list by applying a text classification model that outputs a relevance score for each of a plurality of keyword categories, and to exclude text data records having a relevance score in a predefined exclusion category that exceeds an exclusion threshold.

8. The system according to claim 1, wherein the circuitry is further configured to analyze a history of previously acquired text data records associated with a user by inputting the history as a time-series vector into a sequence classification model, and to determine a priority of text data records to be acquired based on the analysis, the priority being based on at least one of a constructiveness score, a bias score, or a topic interest score output by the sequence classification model.

9. The system according to claim 1, wherein the circuitry is further configured to estimate an emotion of a user and to determine a priority of text data records to be acquired based on the estimated emotion, such that when the estimated emotion indicates a first emotional state, the circuitry increases a priority of acquiring text data records associated with the user, and when the estimated emotion indicates a second emotional state different from the first emotional state, the circuitry decreases the priority.

10. The system according to claim 1, wherein the circuitry is further configured to acquire geographic location information of a user from a client terminal communicatively coupled to the system via the packet-switched network, and to preferentially acquire text data records associated with the geographic location information by computing a region relevance score for each text data record based on the geographic location information.

11. The system according to claim 1, wherein the circuitry is further configured to acquire social media activity data of a user, the social media activity data comprising at least one of posting frequency, engagement count, or follower count, and to adjust a criterion for selecting the subset based on the social media activity data.

12. The system according to claim 1, wherein the circuitry is further configured to generate, for each text data record, a context vector by inputting a sequence of text data records preceding and following the text data record into a model having a self-attention mechanism, and to adjust the classification score based on the context vector, such that the classification score accounts for semantic relationships among text data records in the sequence.

13. The system according to claim 1, wherein the circuitry is further configured to acquire attribute information of a source of each text data record, the attribute information comprising at least one of an age category, an occupation category, or a history of previously submitted text data records, and to adjust the threshold condition based on the attribute information.

14. The system according to claim 1, wherein the circuitry is further configured to estimate an emotion of a user and to adjust a prompt template input to the data generation model based on the estimated emotion, such that when the estimated emotion indicates a first emotional state, the data generation model generates response data having a first expression style, and when the estimated emotion indicates a second emotional state, the data generation model generates response data having a second expression style different from the first expression style.

15. The system according to claim 1, wherein the circuitry is further configured to calculate an importance score for each text data record of the subset based on at least one of a number of past reactions associated with the text data record or a count of expected viewers, and to adjust a level of detail of the response data based on the importance score, such that when the importance score exceeds a first threshold, the circuitry generates detailed response data, and when the importance score is below a second threshold, the circuitry generates concise response data.

16. The system according to claim 1, wherein the circuitry is further configured to classify each text data record of the subset into a category by inputting the respective multidimensional feature vector into a multi-class classification model, and to select, based on the category, a generation algorithm from a plurality of generation algorithms, each generation algorithm being associated with a respective prompt template for the data generation model.

17. The system according to claim 1, wherein the circuitry is further configured to vectorize the response data and entries of a literature database using the Transformer-based sentence embedding model, compute a relevance score between the vectorized response data and each vectorized entry by cosine similarity, and append citation information from entries having relevance scores exceeding a relevance threshold to the response data before transmitting the response data.

18. A system comprising:
circuitry configured to:
acquire, from a data source communicatively coupled to the system via a packet-switched network, a set of text data records, each text data record comprising a comment posted to a comment section of a networked service;
generate, by tokenizing each text data record and inputting the tokenized text data record into a Transformer-based sentence embedding model having a self-attention mechanism, a 768-dimensional sentence embedding vector for each text data record;
generate, by inputting the 768-dimensional sentence embedding vectors into a trained classification model comprising a binary classifier and a multi-class classifier, a fairness score as a continuous value from 0.0 to 1.0 and a constructiveness label for each text data record;
select, based on the fairness scores and the constructiveness labels, a subset of the text data records for which the fairness score is below a fairness threshold or the constructiveness label indicates non-constructive;
generate, by inputting the subset, associated attribute data, and a prompt template into a Transformer-based large language model, response data comprising natural language text presenting an alternative perspective or a constructive response for each text data record of the subset; and
transmit, to the data source via the packet-switched network, the response data for posting to the comment section.

19. The system according to claim 18, wherein the circuitry is further configured to estimate an emotion of a user by inputting at least two of image data of a facial expression into a convolutional neural network, voice waveform data after mel-frequency cepstral coefficient feature extraction into a recurrent neural network, or text input data into a text emotion classifier, integrating outputs of the at least two to generate a final emotion estimation value, and to dynamically adjust the prompt template based on the final emotion estimation value.

20. A method performed by circuitry of a system, the method comprising:
acquiring, from a data source communicatively coupled to the system via a packet-switched network, a set of text data records;
generating, by inputting each text data record of the set into a Transformer-based sentence embedding model, a respective multidimensional feature vector for each text data record;
generating, by inputting the respective multidimensional feature vectors into a trained classification model, a classification score for each text data record, the classification score indicating a degree to which the text data record satisfies a predefined criterion;
selecting, based on the classification scores, a subset of the text data records having classification scores that satisfy a threshold condition;
generating, by inputting the subset and associated attribute data into a data generation model, response data for each text data record of the subset; and
transmitting, to the data source via the packet-switched network, the response data.
